(19) United States
(12) Patent Application Publication
(10) Pub. No.: US 2011/0131079 A1
(43) Pub. Date: Jun. 2, 2011

(54) System and Method for Modeling by Customer Segments

(76) Inventors: Suzanne Valentine, Atlanta, GA (US); Siddharth Patil, San Francisco, CA (US); Paul Algren, Prior Lake, MN (US); William Barrows Peale, Berkeley, CA (US); Robert Parkin, San Francisco, CA (US); Joshua Kneubuhl, Saint Paul, MN (US); Sean McCauley, Minneapolis, MN (US)

(21) Appl. No.: 12/916,591

(22) Filed: Oct. 31, 2010

Related U.S. Application Data
(63) Continuation-in-part of application No. 09/741,956, filed on Dec. 20, 2000, now Pat. No. 7,899,691.

(51) Int. Cl. G06Q 10/00; G06Q 30/00

(52) U.S. Cl. 705/7.31

(57) ABSTRACT

The present invention relates to a system and method for the system and method for modeling demand by consumer segments. In some embodiments a segment data organizer may receive transaction data. Transaction data may include transaction logs (T logs) from point of sales records from a retailer. These transaction logs, for the most part, include identification information for each transaction. The segment data organizer may also receive customer identification data which includes groupings of customers by consumer segments. The identification information within the transaction logs may be cross referenced by the customer identification data in order to generate groupings of transactions belonging to consumers in each segment. The organizer may then also aggregate the transaction logs by location, time series and product. The aggregated data may be supplied to an econometric engine capable of generating elasticity coefficients for each set of aggregate data. These coefficients may be stored or utilized to generate optimized pricing, lifts, and demand models.

### CROSS REFERENCE TO RELATED APPLICATIONS

This is a continuation-in-part of co-pending U.S. application Ser. No. 09/741,956 (Attorney Docket number DT-0003) filed on Dec. 20, 2000, entitled “Econometric Engine”, which is hereby fully incorporated by reference.

### BACKGROUND OF THE INVENTION

The present invention relates to a system and methods for a business tool for modeling customer purchase behavior in a retail setting by consumer segments for the development of targeted and effective merchandising and marketing activity. This business tool may be stand alone, or may be integrated into a pricing optimization system to provide more effective pricing of products. More particularly, the present modeling by segment system may receive segment data and generate coefficients for each customer segment of interest. From these generated coefficients the effects of pricing and promotional changes may be determined or each segment individually, thereby providing a retailer granular insight into consumer behaviors.

For a business to properly and profitably function there must be decisions made regarding product pricing and promotional activity which, over a sustained period, effectively generates more revenue than costs incurred. In order to reach a profitable condition, the business is always striving to increase revenue while reducing costs.

One such method to increase revenue is via proper pricing and promotion of the products or services being sold. Additionally, the use of promotions may generate increased sales which aid in the generation of revenue. Likewise, costs may be decreased by ensuring that only required inventory is shipped and stored. Also, reducing promotion activity reduces costs. Thus, in many instances, there is a balancing between a business activity's costs and the additional revenue generated by said activity. The key to a successful business is choosing the best activities which maximize the profits of the business.

Choosing these profit maximizing activities is not always a clear decision. Markets are a complex set of interactions between individuals in which the best action to take may be counter intuitive. Other times, the profit response to a particular promotion may be counter intuitive. Thus, generating systems and methods for identifying and generating business activities which achieves a desired business result is a prized and elusive goal. Likewise, any system which provides greater insight into consumer behavior is highly sought after by retailers.

Currently, there are numerous methods of generating product pricing through demand modeling and comparison pricing. In these known systems, product demand and elasticity may be modeled to project sales at a given price. The most advanced models include cross elasticity between sales of various products. While these methods of generating prices and promotions may be of great use to a particular business, there are a number of problems with these systems. Primarily, these methods and systems only look at the average effects across all consumers. There is little visibility into how actual consumers behave using these systems, within the consumer base, thereby limiting the specificity of business activities to a particular group of the consumer base (i.e., segment).

Returning to the basic principles of sound business management, that being increasing revenue while reducing costs, by introducing specificity of the consumer base in the generation of business decisions a store may achieve more targeted (less cost) promotions which more effectively (increased revenue) influence the purchasing behaviors of the relevant consumers.

It is therefore apparent that an urgent need exists for modeling purchase behavior for customer segments. This improved modeling by segment system enables generating more granular demand coefficients, for each segment of interest, than has been available previously. These coefficients may be utilized in downstream activities to provide highly targeted promotions and more effective promotional activity. When coupled to a pricing optimization system, the modeling by segment system may generate more finely tuned pricing for given products. This modeling by segment system provides businesses with an advanced competitive tool to greatly increase business profitability while offering consumers more value on the products they demand.

### SUMMARY OF THE INVENTION

To achieve the foregoing and in accordance with the present invention, a system and method for modeling by customer segment is provided. In particular the system and methods for modeling by segment enables the generation of elasticity coefficients to be generated for each product, location and segment. This enables greater insight into segment behavior and reaction to pricing and promotional activity.

In some embodiments, the system and method for modeling demand by consumer segments may be utilized in conjunction with a price optimization system in order to effectuate pricing optimizations. In some embodiments a segment data organizer may receive transaction data. Transaction data may include transaction logs (T logs) from point of sales records from a retailer. These transaction logs, for the most part, include customer identification information for each transaction. Much of the identification information is derived from loyalty plans and memberships.

In addition to receiving transaction logs, the segment data organizer may also receive customer identification data which includes groupings of customers by consumer segments. The identification information within the transaction logs may be cross referenced by the customer identification data in order to generate groupings of transactions belonging to consumers in each segment. The organizer may then also aggregate the transaction logs by location, time series and product.

The aggregated data may be supplied to an econometric engine capable of generating elasticity coefficients for each set of aggregate data. This results in demand coefficients to be generated for each segment, in each location (or location group) for each product. These coefficients may be utilized to generate optimized pricing and promotion, lifts and demand models by an optimization engine. The coefficients may likewise be stored for future retrieval in a database.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a high level schematic view of an embodiment of a price optimization system with an segment data organizer capable of modeling by customer segments, in accordance with some embodiment;

FIG. 2 is high level flow chart of an optimization process, in accordance with some embodiment;

FIG. 3 is a more detailed schematic view of the econometric engine, in accordance with some embodiment;

FIG. 4 is a more detailed schematic view of the optimization engine and support tool, in accordance with some embodiment;

FIG. 5 is a block diagram to illustrate some of the transaction costs that occur in retail businesses of a chain of stores, in accordance with some embodiment;

FIG. 6 is a flow chart of some embodiment of the invention for providing an initial feasible solution, in accordance with some embodiment;

FIGS. 7A and 7B illustrate a computer system, which forms part of a network and is suitable for implementing embodiments;

FIG. 8 is a schematic illustration of an embodiment that functions over a network;

FIG. 9A is a graph of original profit from actual sales of the store using actual prices and optimal profit from optimized sales resulting from the calculated optimized prices bounded by its probability, in accordance with some embodiment;

FIG. 9B is a graph of percentage increase in profit and the probability of obtaining at least that percentage increase in profit, in accordance with some embodiment;

FIG. 10 is a flow chart depicting a process flow by which raw econometric data can be input, subject to “cleansing”, and used to create an initial dataset which can then be used to generate imputed econometric variables in accordance with some embodiment;

FIG. 11 is a flow chart depicting a process flow depicting a process by which partially cleansed econometric data is subject to further error detection and correction in accordance with some embodiment;

FIG. 12 is a flow chart depicting a process flow by which an imputed base price variable can be generated in accordance with one embodiment;

FIG. 13 is a flow chart depicting a process flow by which an imputed relative price variable can be generated in accordance with one embodiment;

FIG. 14A is a flow chart depicting a process flow by which an imputed base unit sales volume variable can be generated in accordance with one embodiment;

FIG. 14B is a diagram used to illustrate the comparative effects of sales volume increase and price discounts;

FIG. 15A is a flow chart depicting a process flow by which supplementary error detection and correction in accordance with an embodiment;

FIG. 15B is a diagram used to illustrate the comparative effects of sales volume increase and price discounts;

FIG. 16 is a flow chart depicting a process flow by which an imputed stockpiling variable can be generated in accordance with an embodiment;

FIG. 17 is a flow chart depicting a process flow by which an imputed day-of-week variable can be generated in accordance with an embodiment;

FIG. 18 is a flow chart depicting a process flow by which an imputed seasonality variable can be generated in accordance with an embodiment;

FIG. 19 is a flow chart depicting a process flow by which an imputed promotional effects variable can be generated in accordance with an embodiment;

FIG. 20 is a flow chart depicting a process flow by which an imputed cross-elasticity variable can be generated in accordance with some embodiment;

FIG. 21 is a more detailed schematic view of the customer segment data organizer, in accordance with some embodiment;

FIG. 22 is a more detailed schematic view of the data warehouse, in accordance with some embodiment;

FIG. 23 is a more detailed schematic view of the database, in accordance with some embodiment;

FIG. 24 is a workflow flowchart for modeling by segment, in accordance with some embodiment;

FIGS. 25A and 25B is a flow chart depicting a process flow by which transaction data is modeled by customer segments, in accordance with some embodiment;

FIG. 26 is an example diagram of generating models for transaction data, in accordance with some embodiment;

FIG. 27 is an example diagram of generating models for segmented transaction data, in accordance with some embodiment;

FIG. 28 is an example plot of a products demand curves for numerous segments, in accordance with some embodiment;

FIG. 29 is an example pair of bar graphs illustrating item strength generally and by a selected segment, in accordance with some embodiment;

FIG. 30 is an example plot of average category lift by segment for a proposed promotional activity, in accordance with some embodiment; and

FIG. 31 an example user interface for the model by segment system, in accordance with some embodiment.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to a system and methods for a business tool for modeling demand by consumer segments, in a retail setting, for customer insights, business planning and downstream activities such as promotions. This business tool may be stand alone, or may be integrated into a pricing or promotion optimization system to provide more effective pricing of products. For example, the customer segment data may be incorporated into promotion optimization to modify the discounted price and promotion activities at the retailer to achieve a desired purchasing behavior in the target customer segment. More particularly, the present modeling by segment system may aggregate transactional records by consumer segments to generate demand coefficients for each segment.

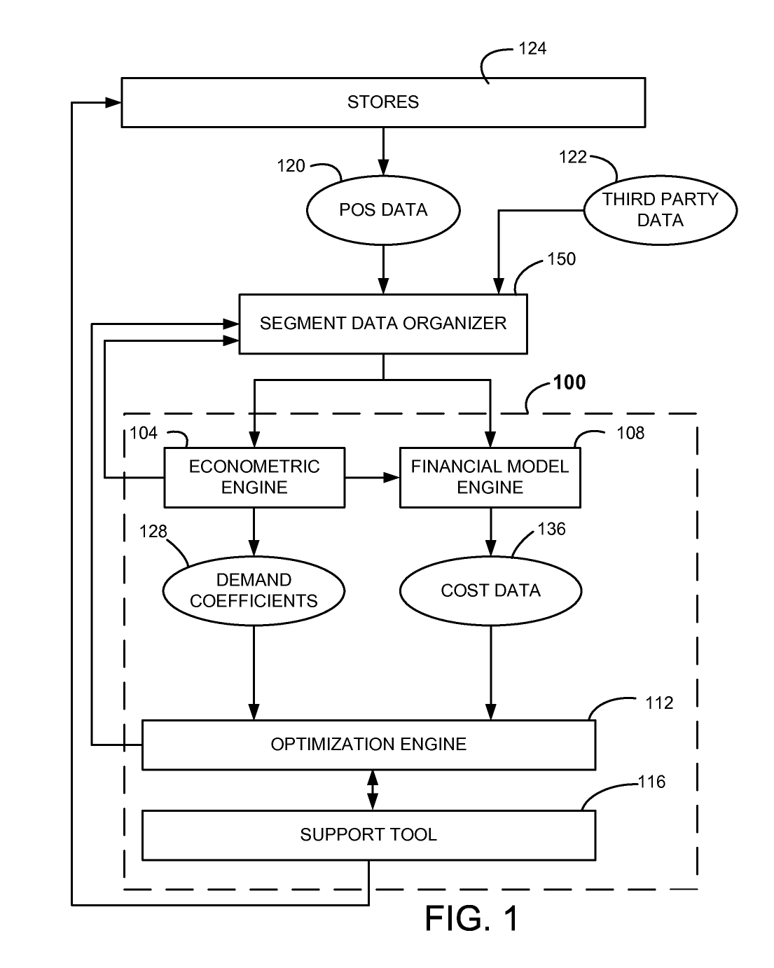

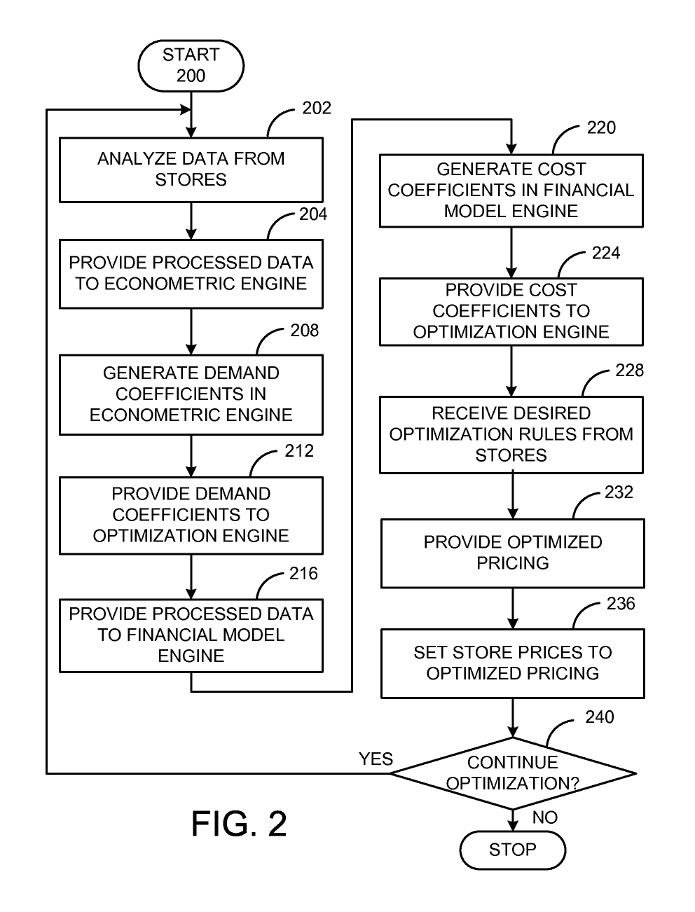

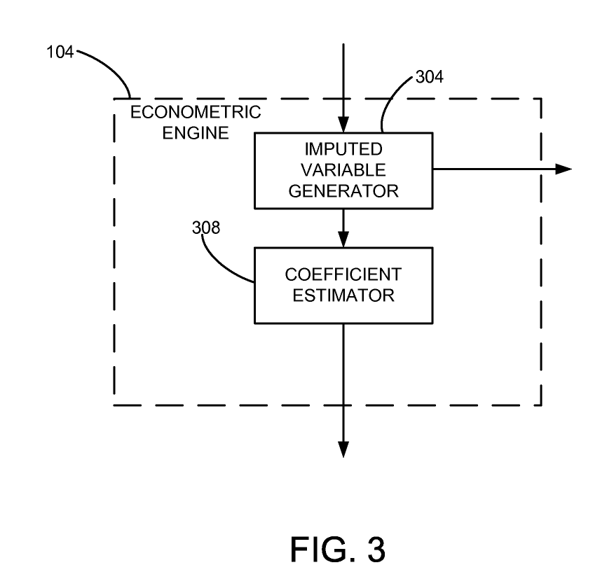

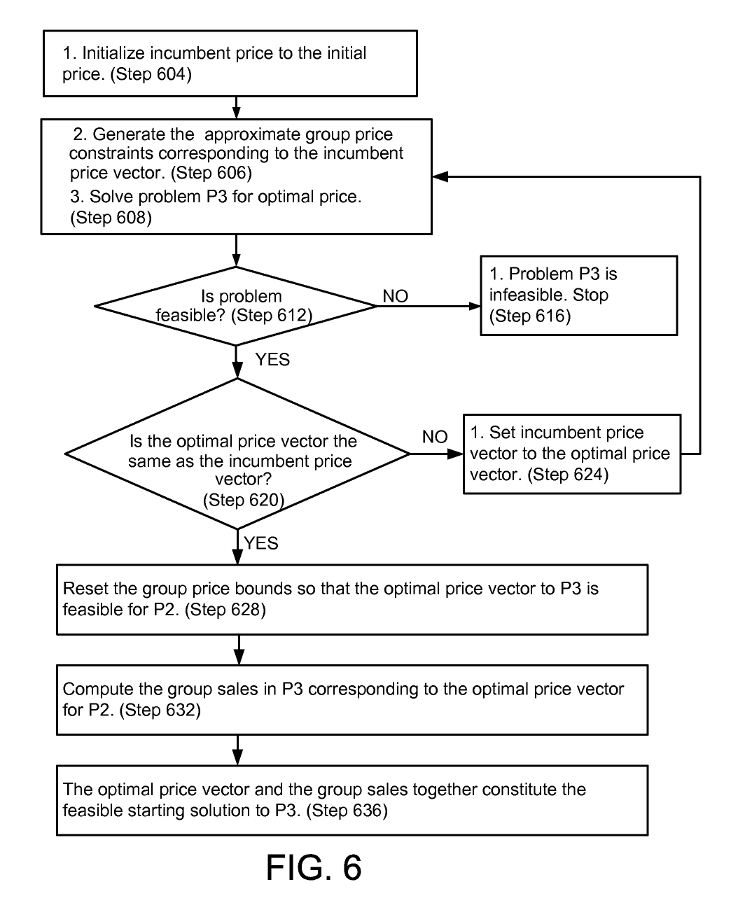

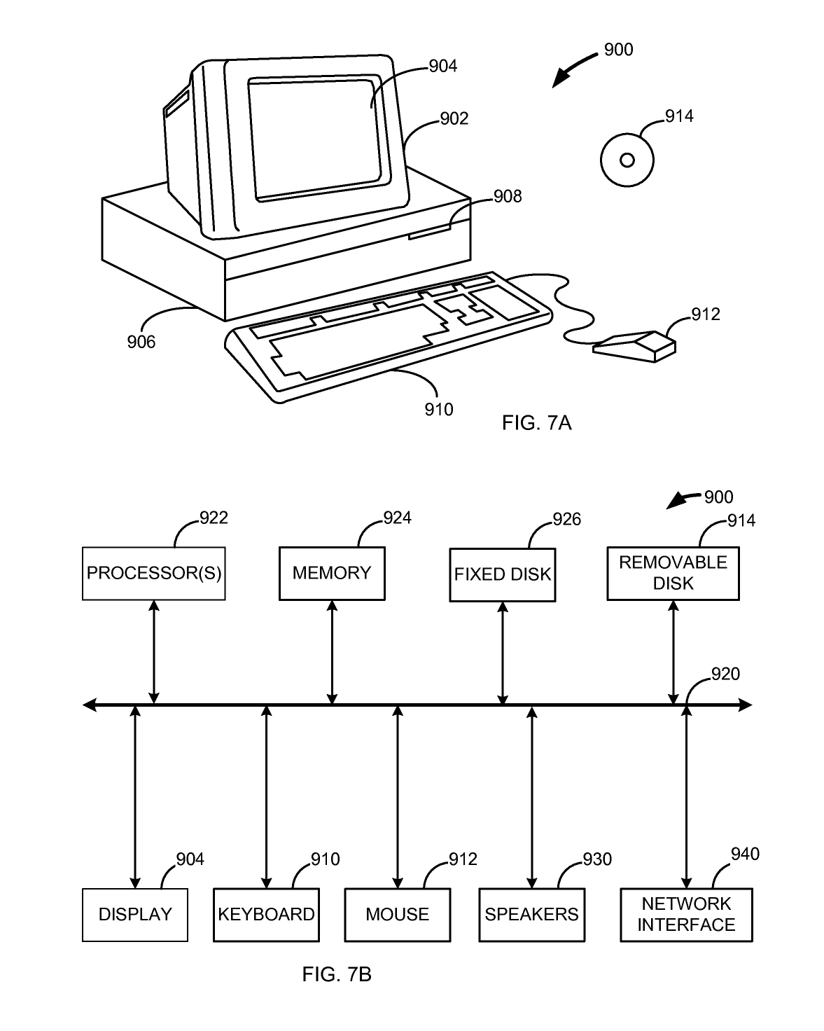

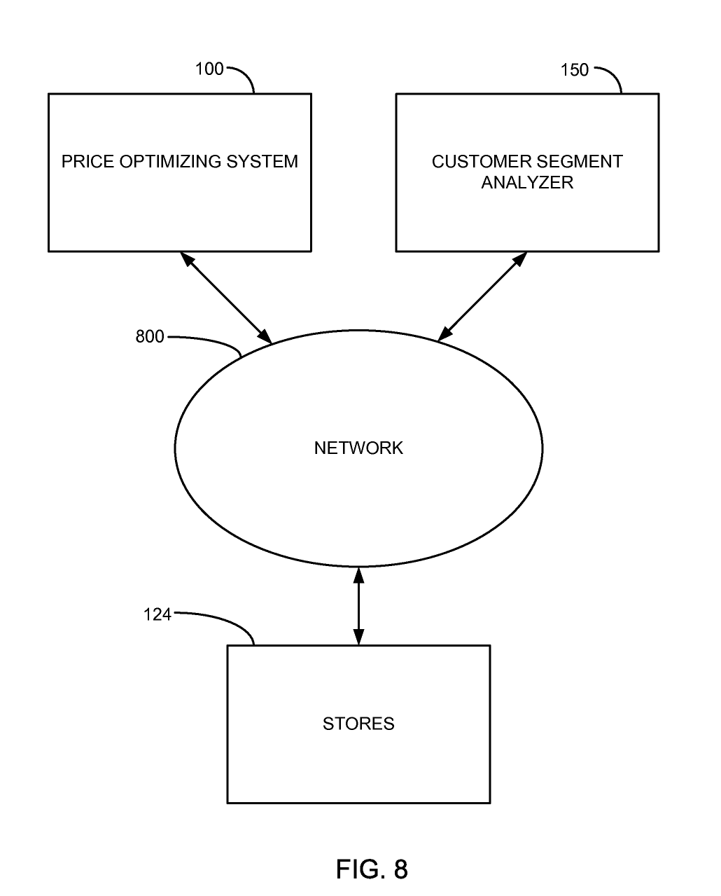

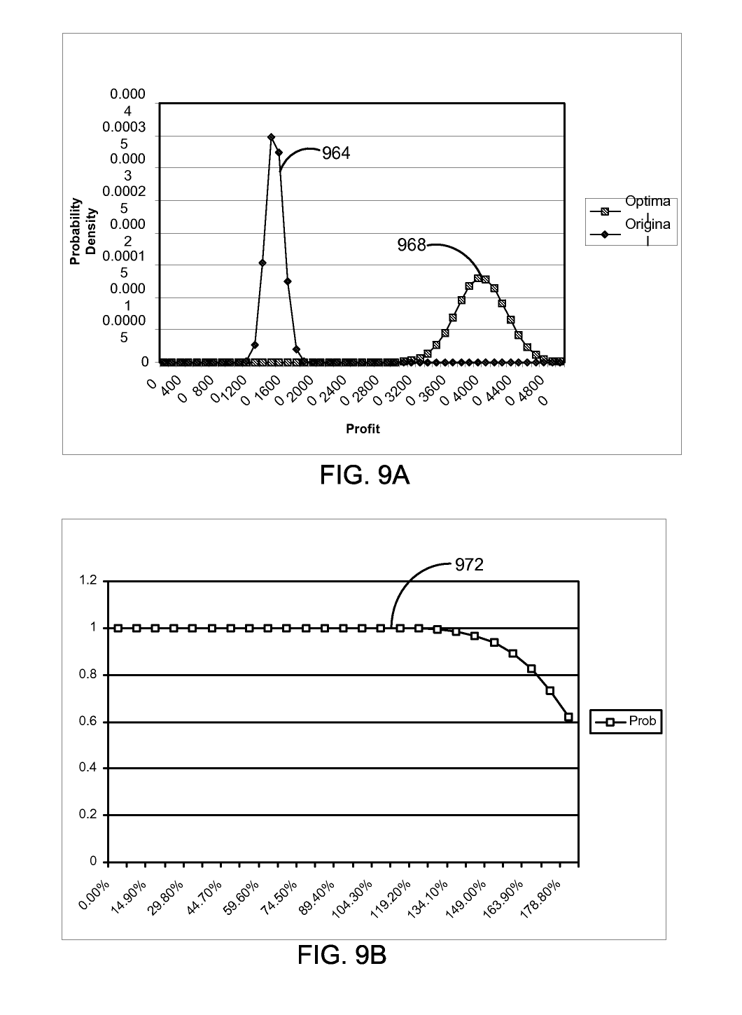

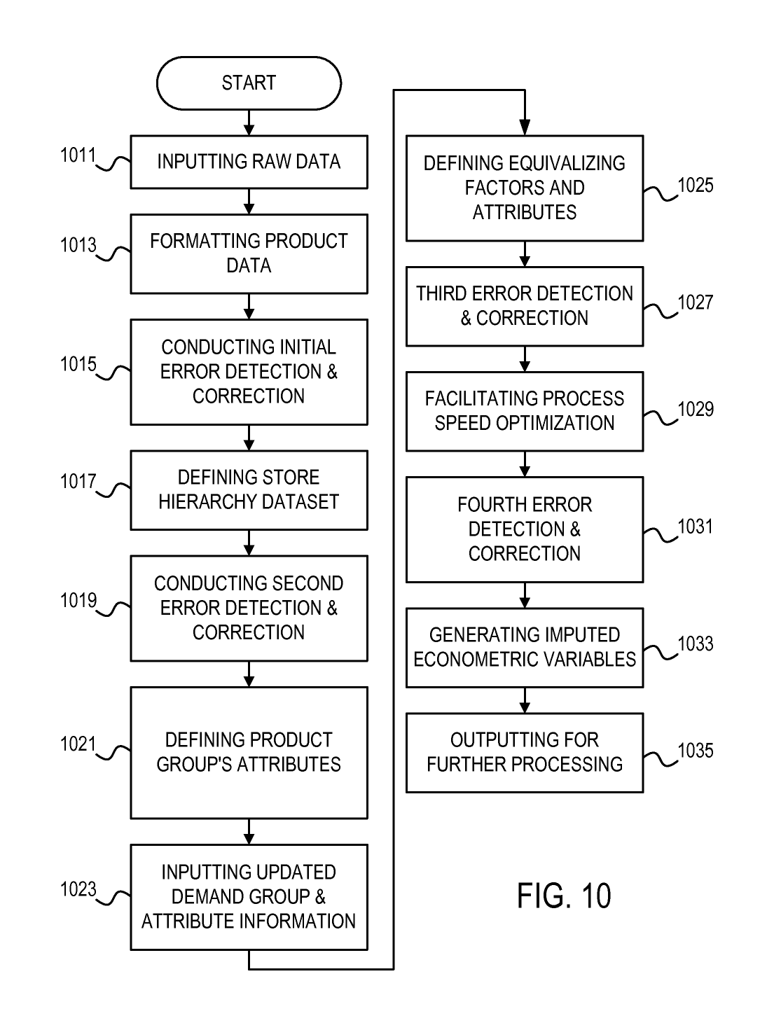

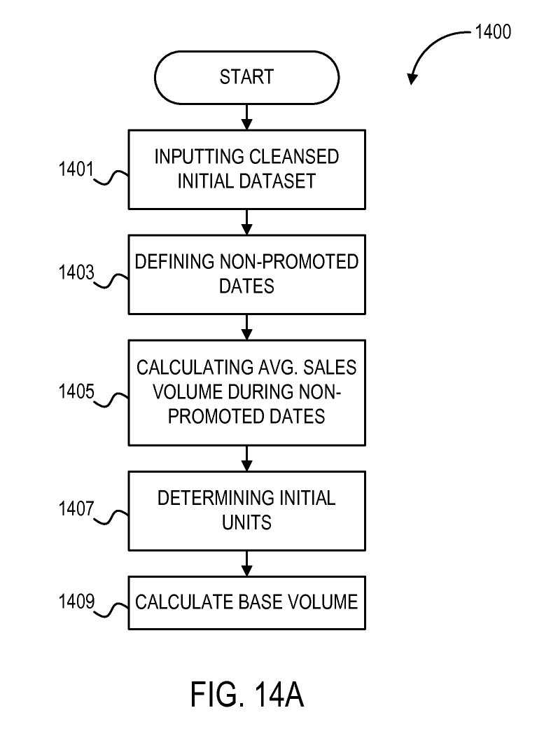

To facilitate discussion, FIGS. 1 and 2 show an optimization system and methods for such a system. The optimization system may be leveraged, using a segment data organized to generate and utilize coefficients for consumer segments of interest. FIGS. 3-6 illustrate the optimization system and methods in more detail. General computer systems for the optimization system and retention system may be seen at FIGS. 7 and 8. FIGS. 9 to 12D illustrate data error correction for optimization. FIGS. 13-20 show various pricing optimization processes.

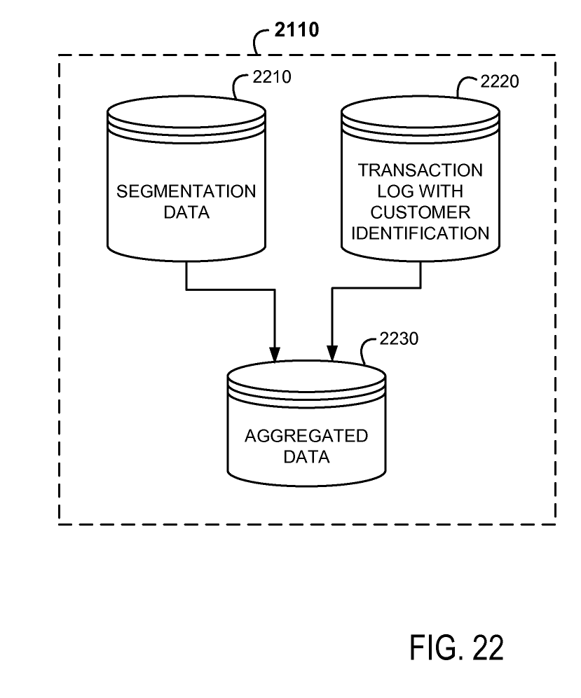

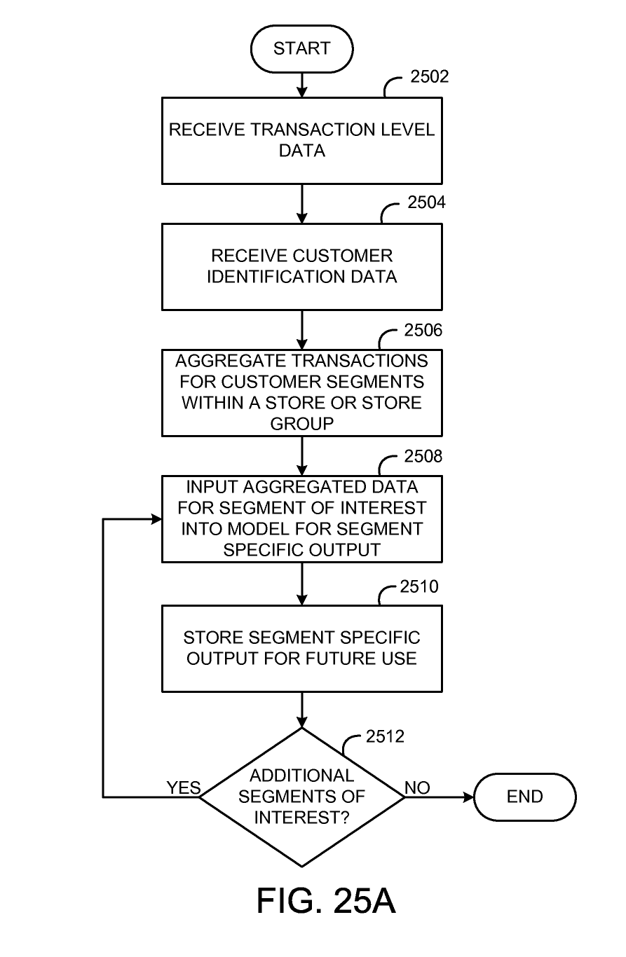

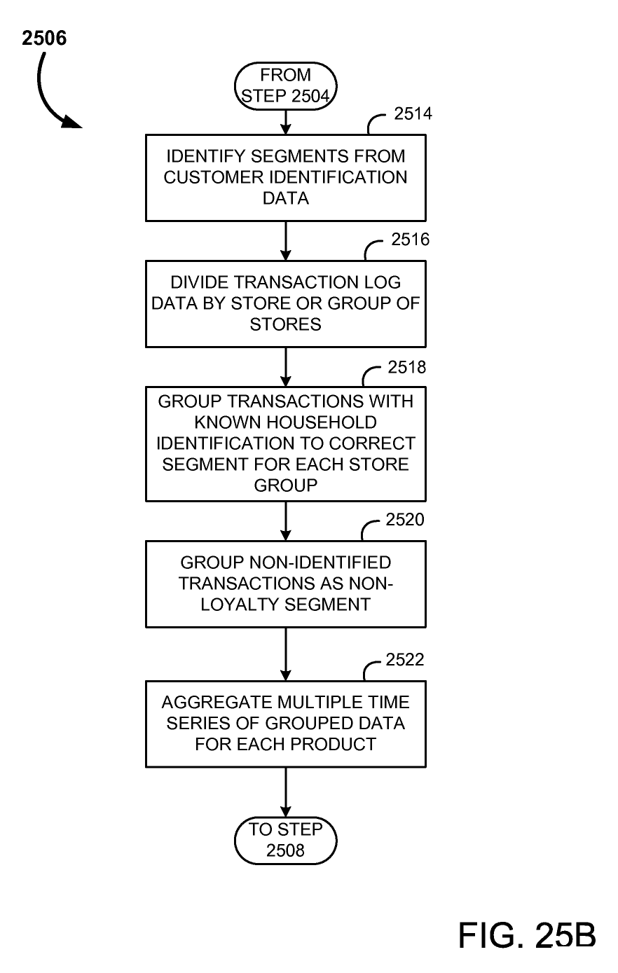

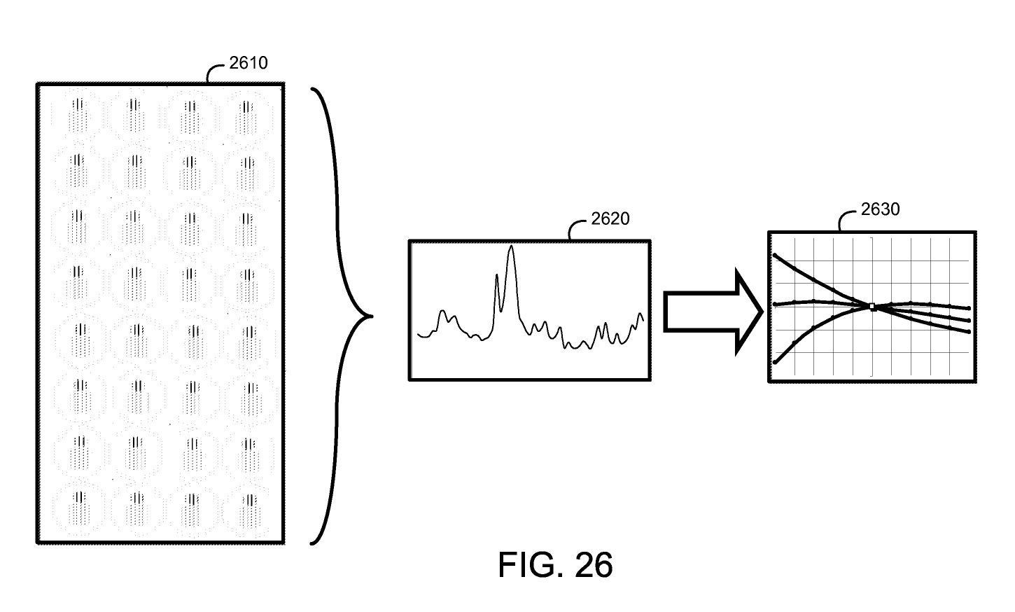

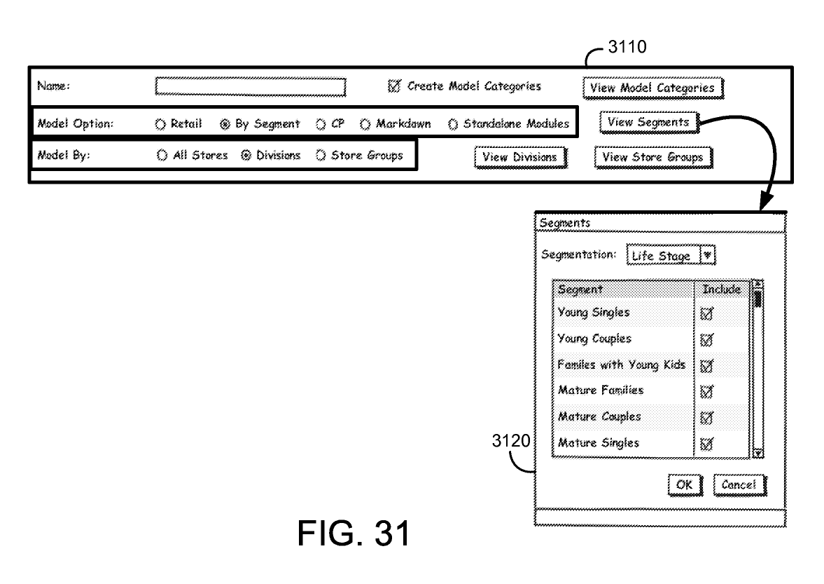

FIGS. 21 to 23 detail the segment data organizer FIGS. 24 and 25 illustrate the method of modeling by customer segments. FIGS. 26 to 30 illustrate example charts for describing the process, results and insights gathered from modeling by consumer segments. Lastly, FIG. 31 illustrates a user interface for the modeling by segment system in accordance with some embodiments.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. Optimization System Overview

To facilitate discussion, FIG. 1 is a schematic view of a Price Optimizing System 100 useful for generating models by segment when coupled to a Segment Data Organizer 150. Some embodiments of the Price Optimizing System 100 comprises an Econometric Engine 104, a Financial Model Engine 108, an Optimization Engine 112, a Support Tool 116, and a Customer Segment Data Organizer 150. The Econometric Engine 104 is connected to the Optimization Engine 112, so that the output of the Econometric Engine 104 is an input of the Optimization Engine 112. The Financial Model Engine 108 is connected to the Optimization Engine 112, so that the output of the Financial Model Engine 108 is an input of the Optimization Engine 112. Likewise, the Segment Data Organizer 150 is connected to the Financial Model Engine 108 and the Econometric Engine 104, so that the output of the Segment Data Organizer 150 is an input of the Financial Model Engine 108 and the Econometric Engine 104.

The Optimization Engine 112 is connected to the Support Tool 116 so that output of the Optimization Engine 112 is provided as input to the Support Tool 116 and output from the Support Tool 116 may be provided as input to the Optimization Engine 112. Likewise, both the Optimization Engine 112 and the Econometric Engine 104 are connected to the Segment Data Organizer 150 so that feedback from the Optimization Engine 112 and the Econometric Engine 104 is provided to the Segment Data Organizer 150. The Econometric Engine 104 may also exchange data with the Financial Model Engine 108.

Point of Sales (POS) Data 120 is provided from the Stores 124 to the Segment Data Organizer 150. Also, Third Party Data 122 may be utilized by the Segment Data Organizer 150 for the proper inputting of modeling aggregates into the Econometric Engine 104.

FIG. 2 is a high level flow chart of a process that utilizes the Price Optimizing System 100. The operation of the Price Optimizing System 100 will be discussed in general here and in more detail further below. Data 120 is provided from the Stores 124 to the Segment Data Organizer 150 for use in modeling by segment (step 202). Generally, the data 120 provided to the Segment Data Organizer 150 may be point-of-sale information, product information, and store information. Additionally, the Segment Data Organizer 150 may receive data form third parties for the proper processing and aggregation of data. Processed data (cleansed and aggregated by product, location and segment) may then be provided to the Econometric Engine 104 (step 204). The Econometric Engine 104 processes the analyzed data to provide demand coefficients 128 for each segment of interest (step 208) for a set of algebraic equations that may be used to estimate demand (volume sold) given certain marketing conditions (i.e. a particular store in the chain), including a price point. The demand coefficients 128 are provided to the Optimization Engine 112.

Additional processed data from the Econometric Engine 104 may also be provided to the Optimization Engine 112. The Financial Model Engine 108 may receive processed data from the Segment Data Organizer 150 (step 216) and processed data from the Econometric Engine 104. Data may also be received from the stores. This data is generally cost related data, such as average store labor rates, average distribution center labor rates, cost of capital, the average time it takes a cashier to scan an item (or unit) of product, how long it takes to stock a received unit of product and fixed cost data. The Financial Model Engine 108 may process all the received data to provide a variable cost and fixed cost for each unit of product in a store. The processing by the Econometric Engine 104 and the processing by the Financial Model Engine 108 may be done in parallel. Cost data 136 is provided from the Financial Model Engine 108 to the Optimization Engine 112 (step 224). The Optimization Engine 112 utilizes the demand coefficients 128 to create a demand equation, again by each segment of interest. The optimization engine is able to forecast demand and cost for a set of prices to calculate net profit, as well as profit derived from each segment, profit lift by segment, and the like. The Stores 124 may use the Support Tool 116 to provide optimization rules to the Optimization Engine 112 (step 228).

The Optimization Engine 112 may use the demand equation, the variable and fixed costs, the rules, and retention data to compute an optimal set of prices that meet the rules (step 232). For example, if a rule specifies the maximization of profit across all segments, the optimization engine would find a set of prices that cause the largest difference between the total sales and the total cost of all products being measured. If a rule providing a promotion of one of the products by specifying a discounted price is provided, the optimization engine may provide a set of prices that allow for the promotion of the one product and the maximization of profit under that condition. In the specification and claims the phrases “optimal set of prices” or “preferred set of prices” are defined as a set of computed prices for a set of products where the prices meet all of the rules. The system may maximize an objective function subject to these rules; the objective function may vary, such as optimizing profit or optimizing volume of sales of a product and constraints such as a limit in the variation of prices. The optimal (or preferred) set of prices is defined as prices that define a local optimum of an econometric model which lies within constraints specified by the rules When profit is maximized, it may be maximized for a sum of all measured products.

Such a maximization, may not maximize profit for each individual product, but may instead have an ultimate objective of maximizing total profit. The optimal (preferred) set of prices may be sent from the Optimization Engine 112 to the Support Tool 116 so that the Stores 124 may use the user interface of the Support Tool 116 to obtain the optimal set of prices. Other methods may be used to provide the optimal set of prices to the Stores 124. The price of the products in the Stores 124 are set to the optimal set of prices (step 236), so that a maximization of profit or another objective is achieved. An inquiry may then be made whether to continue the optimization (step 240). The Optimization Engine and Support tool also allow users to create and compare scenarios with different objectives and different rule sets so that the retailer can evaluate the costs of rules and select the scenario which best fits their strategy for that group of products, stores and consumers.

Each component of the Price Optimizing System 100 will be discussed separately in more detail below.

### II. Econometric Engine

FIG. 3 is a more detailed view of the Econometric Engine 104. The econometric engine comprises an Imputed Variable Generator 304 and a Coefficient Estimator 308. The data 120 from the Stores 124 is provided to the Imputed Variable Generator 304. The data 120 may be raw data generated from cash register data, which may be generated by scanners used at the cash registers. Additionally, processed customer segment data, aggregated by product-location-segment, may be provided to the Imputed Variable Generator 304 from the Segment Data Organizer 150.

### A. Imputed Variable Generator

The present invention provides methods, media, and systems for generating a plurality of imputed econometric variables. Such variables are useful in that they aid businesses in determining the effectiveness of a variety of sales strategies. In particular, such variables can be used to gauge the effects of various pricing or sales volume strategies.

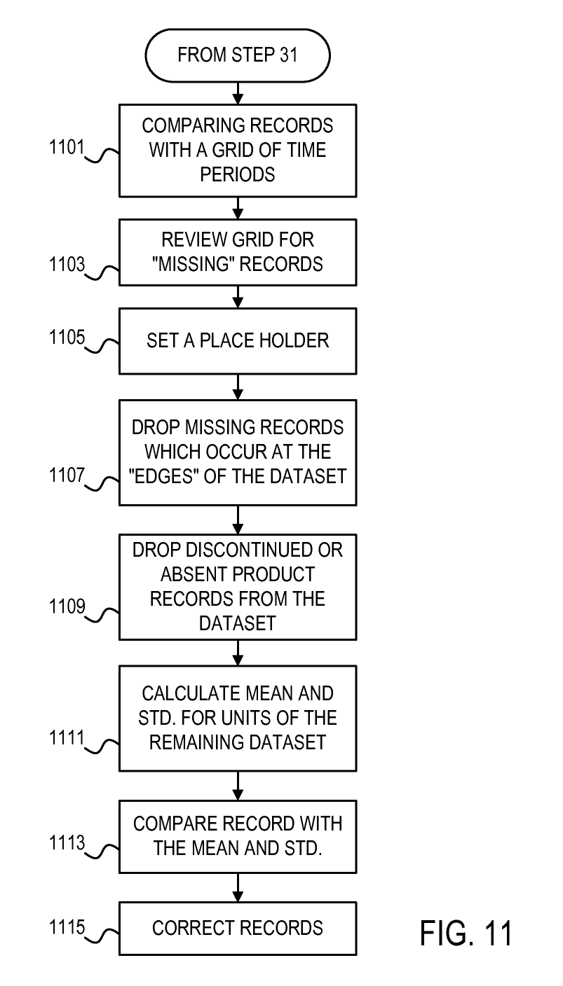

FIG. 10 illustrates a flowchart 1000 which describes steps of a method embodiment for data cleansing imputed econometric variable generation in accordance with the principles of the present invention. The process, generally described in FIG. 10, begins by initial dataset creation and data cleaning (Steps 1011-1031). This data set information is then used to generate imputed econometric variables (Step 1033) which can be output to and for other applications (Step 1035). Likewise, such dataset correction and cleansing

1. Initial Dataset Creation and Cleaning

The process of dataset creation and cleaning (that is to say the process of identifying incompatible data records and resolving the data incompatibility, also referred to herein as “error detection and correction”) begins by inputting raw econometric data (Step 1011). The raw econometric data is then subject to formatting and classifying by UPC designation (Step 1013). After formatting, the data is subject an initial error detection and correction step (Step 1015). Once the econometric data has been corrected, the store information comprising part of the raw econometric data is used in defining a store data set hierarchy (Step 1017). This is followed by a second error detecting and correcting step (Step 1019). In some embodiments this is followed by defining a group of products which will comprise a demand group (i.e., a group of highly substitutable products) and be used for generating attribute information (Step 1021). Based on the defined demand group, the attribute information is updated (Step 1023). The data is equivalized and the demand group is further classified in accordance with size parameters (Step 1025). The demand group information is subjected to a third error detection and correction step (Step 1027). The demand group information is then manipulated to facilitate decreased process time (Step 1029). The data is then subjected to a fourth error detection and correction step (Step 1031), which generates an initial cleansed dataset. Using this initial cleansed dataset, imputed econometric variables are generated (Step 1033). Optionally, these imputed econometric variables may be output to other systems for further processing and analysis (Step 1035).

While this exemplary process of generating an initial dataset with cleansing is provided with some degree of detail, it is understood that the process for predicting customer loss and customer retention strategy generation may be performed with a variety of optimization systems. This includes systems where, for example, demand groups are not generated, and where alternative methods of data set generation are employed.

The process begins by inputting raw econometric data (Step 1011). The raw econometric data is provided by a client. The raw econometric data includes a variety of product information, including, but not limited to, the store from which the data is collected, the time period over which the data is collected, a UPC (Universal Product Code) for the product, and provide a UPC description of the product. Also, the raw econometric data must include product cost (e.g., the wholesale cost to the store), number of units sold, and either unit revenue or unit price. Also, the general category of product or department identification is input. A category is defined as a set of substitutable or complementary products, for example, “Italian Foods”. Such categorization can be proscribed by the client, or defined by generally accepted product categories. Additionally, such categorization can be accomplished using look-up tables or computer generated product categories.

Also, a more complete product descriptor is generated using the product information described above and, for example, a UPC description of the product and/or a product description found in some other look-up table (Step 1013).

The data is then subjected to a first error detection and correction process (Step 1015). Typically, this step includes the removal of all duplicate records and the removal of all records having no match in the client supplied data (typically scanner data).

Data subsets concerning store hierarchy are defined (Step 1017). This means stores are identified and categorized into various useful subsets. These subsets can be used to provide information concerning, among other things, regional or location specific economic effects.

The data is then subjected to a second error detection and correction process (Step 1019). This step cleans out certain obviously defective records. Examples include, but are not limited to, records displaying negative prices, negative sales volume, or negative cost. Records exhibiting unusual price information, determined through standard deviation or cross store comparisons, are also removed.

This is followed by defining groups of products and their attributes and exporting this information to a supplementary file (e.g., a text file) (Step 1021). This product information can then be output into a separate process which can be used to define demand groups or product attributes. For example, this supplemental file can be input into a spreadsheet program (e.g., Excel®) which can use the product information to define “demand groups” (i.e., groups of highly substitutable products). Also, further product attribute information can be acquired and added to the supplementary file. In addition, updated demand group and attribute information can then be input as received (Step 1023). By maintaining a supplementary file containing large amounts of data, a more streamlined (abbreviated) dataset may be used in processing, thereby effectively speeding up processing time.

The data is further processed by defining an “equivalizing factor” for the products of each demand group in accordance with size and UOM parameters (Step 1025). This equivalizing factor can be provided by the client or imputed. An equivalizing factor can be imputed by using, for example, the median size for each UOM. Alternatively, some commonly used arbitrary value can be assigned. Once this information is gathered, all product prices and volume can be “equivalized”. Chiefly, the purpose of determining an equivalizing factor is to facilitate comparisons between different size products in a demand group.

The data is then subjected to a third error detection and correction process, which detects the effects of closed stores and certain other erroneous records (Step 1027). In accord with the principles of the invention, stores that demonstrate no product movement (product sales equal to zero) over a predetermined time period are treated as closed. Those stores and their records are dropped from the process. The third error detection and correction also includes analysis tools for detecting the presence of erroneous duplicate records. A further correction can be made for records having the same date and causal value but have differing prices or differing number of units sold.

After all the duplicate records eliminated, the data is reconstructed. The data can be reviewed again to insure all duplicates are removed. Optionally, an output file including all discrepancies can be produced. In the event that it becomes necessary, this output file can be used as a follow-up record for consulting with the client to confirm the accuracy of the error detection and correction process.

Additionally, reduced processing times may be achieved by reformatting the data (Step 1029). For example, groups of related low sales volume products (frequently high priced items) can optionally be aggregated as a single product and processed together. Additionally, the data may be split into conveniently sized data subsets defined by a store or groups of stores which are then processed together to shorten the processing times.

Next the process includes determining the nature of missing data records in a fourth error detection and correction step (Step 1031). The missing data records are analyzed again before finally outputting a cleansed initial dataset. For example, data collected over a modeled time interval is analyzed by introducing the data into a data grid divided into a set of time periods. For the time periods having no records a determination must be made. Is the record missing because:

a. there were no sales that product during that week (time period);

b. the product was sold out and no stock was present in the store during that time period (this situation is also referred to herein as a “stock-out');

c. the absence of data is due to a processing error.

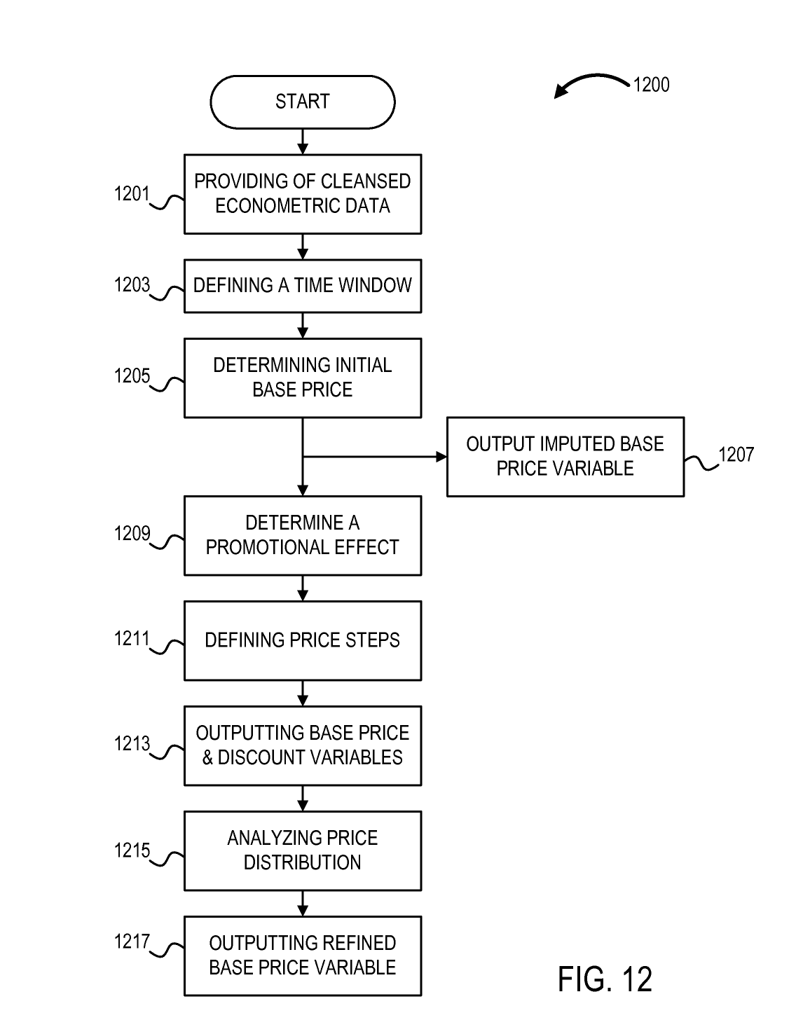

FIG. 11 depicts an exemplary process flow embodiment for determining the nature of missing data records in a fourth error detection and correction step in accordance with the principles of the present invention. The records are compared to a grid of time periods (Step 1101). The grid is reviewed for missing records with respect to a particular store and product (Step 1103). These missing records are then marked with a placeholder (Step 1105). Missing records at the “edges” of the dataset do not significantly affect the dataset and are deleted (Step 1107). Records for discontinued products or products recently introduced are dropped for those time periods where the product was not carried in the Store (Step 1109). The remaining dataset is processed to determine an average value for units (sold) and a STD for units (Step 1111). Each missing record is compared to the average units (Step 1113) and based on this comparison, a correction can be made (Step 1115).

The net result of execution of the process Steps 1011-1031 disclosed hereinabove is the generation of a cleansed initial dataset which can be used for its own purpose or input into other econometric processes. One such process is the generation of imputed econometric variables.

Note that other methods for addressing missing records may be utilized, as is well known by those skilled in the art. For example, missing records may be simply dropped. Alternatively, such records may be incorporated with additional information such as extrapolated values form before and/or after the data point, median values or other replacement value.

2. Generation of Imputed Econometric Variables

The foregoing steps (1011-1031) concern cleansing the raw econometric data to create an error detected and error corrected (“cleansed”) initial dataset. The cleansed initial dataset created in the foregoing steps can now be used to generate a variety of useful imputed econometric variables (Step 1033). These imputed econometric variables are useful in their own right and may also be output for use in further processing (Step 1035). One particularly useful application of the imputed econometric variables is that they can be input into an optimization engine which collects data input from a variety of sources and processes the data to provide very accurate economic modeling information.

A. Imputed Base Price

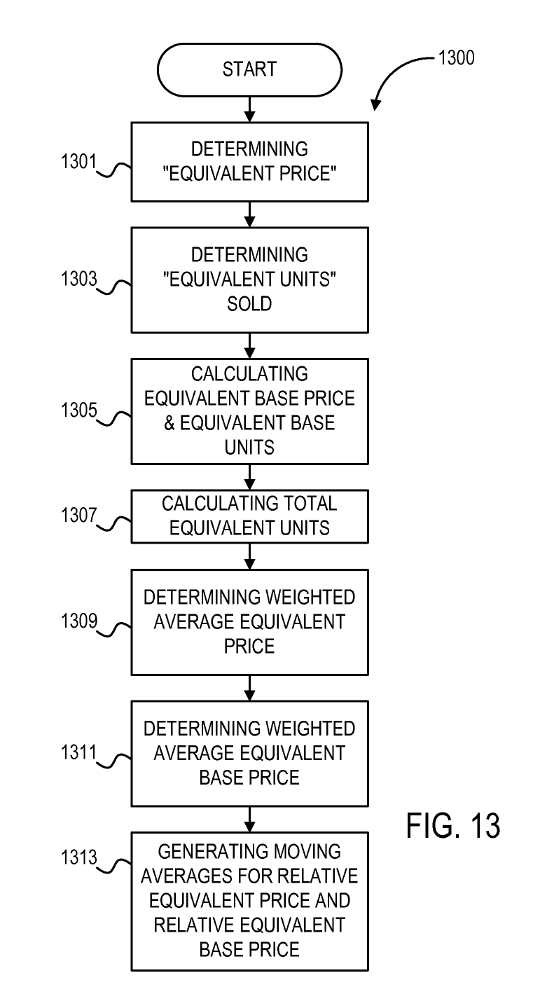

One imputed econometric variable that can be determined using the initial dataset created in accordance with the forgoing, is an imputed base price variable (or base price). FIG. 12 is a flowchart 1200 outlining one embodiment for determining the imputed base price variable. The process begins by providing the process 1200 with a “cleansed” initial dataset (Step 1201), for example, the initial dataset created as described in Steps 1011-1031 of FIG. 10. The initial dataset is examined over a defined time window (Step 1203). Defining a time window (Step 1203) includes choosing an amount of time which frames a selected data point allowing one to look forward and backward in time from the selected data point which lies at the midpoint in the time window. This is done for each data point in the dataset, with the time window being defined for each selected data point. The time frame can be user selected or computer selected.

The initial base price values generated above provide satisfactory values for the imputed base price variable which may be output (Step 1207) and used for most purposes. However, optional Steps 1209-1217 describe an approach for generating a more refined imputed base price variable.

In generating a more refined imputed base price variable, the effect of promotional (or discount) pricing is addressed (Steps 1209-1217). This may be calculated by specifying a discount criteria (Step 1209); defining price steps (Step 1211); outputting an imputed base price variable and an imputed discount variable (Step 1213); analyzing the base price distribution (Step 1215); and outputting a refined base price variable (Step 1217).

Data records are evaluated over a series of time periods (e.g., weeks) and evaluated. The point is to identify price records which are discounted below a base price. By identifying these prices and not including them in a calculation of base price, the base price calculation will be more accurate. Therefore, a discount criterion is defined and input as a variable (Step 1209).

Further analysis is used to define base price “steps” (Step 1211). Base price data points are evaluated. Steps are roughly defined such that the base price data points lie within a small percent of distance from the step to which they are associated (e.g., 2%). This can be accomplished using, for example, a simple regression analysis such as is known to those having ordinary skill in the art. By defining the steps, the average value for base price over the step is determined. Also, price data points are averaged to determine the base price of step. Thus, the average of the base prices in a step is treated as the refined base price for that step.

Further refining includes an analysis of the first step. If the first step is short (along the time axis) and considerably lower than the next step, it is assumed that the first step is based on a discounted price point. As such, the value of the next step is treated as the base price for the time period of the first step.

At this point, absolute discount (ΔP) and base price (BP) are used to calculate percent discount (ΔP/BP) for each store product time period.

This base price is subjected to further analysis for accuracy using cross-store checking (Step 1215). This can be accomplished by analyzing the base price data for each product within a given store, and comparing with all other stores. Any outlier store's base price is adjusted for the analyzed product such that it lies closer to an average cross-store percentile for base price over all stores.

Thus, the forgoing process illustrates an embodiment for determining an imputed base price variable.

B. Imputed Relative Price Variable

Reference is now made to the flowchart 1300 of FIG. 13 which illustrates an embodiment for generating relative price variables in accordance with the principles of the present invention. A relative price may be calculated. As disclosed earlier, an equivalizing factor is defined. Using the equivalizing factor, an equivalent price can be calculated (Step 1301). Next equivalent units sold (“units”) can be calculated (Step 1303). In a similar vein, equivalent base price and equivalent base units are calculated (Step 1305) using the imputed values for base price (for example, as determined in Steps 1201-1207) and for base units (also referred to as base volume which is determined as disclosed below). For each Store, each demand group, and each date, the total equivalent units is determined (Step 1307). A weighted calculation of relative equivalent price is then made (Step 1309).

For example, such relative price value is determined as follows: equivalent price is divided by a weighted denominator, the weighted denominator is calculated by multiplying equivalent units for each product times the equivalent units sold. For each product, only the values of other products are used in the calculation. This means excluding the product being analyzed. For example, the relative price of A, given three exemplary products A, B and C, is determined as follows:

$${rel}_{A} = \frac{equiv \cdot priceofA}{[ \frac{\begin{matrix}( equiv \cdot unitsofB ) ( Equiv \cdot priceofB ) + \\ ( equiv \cdot unitsofC ) ( equiv \cdot priceofC )\end{matrix}}{totalequivalentunits - equivalentunitsofA} ]}$$

Also, a weighted average equivalent base price is calculated using the method disclosed hereinabove. The only difference being that instead of using the actual equivalent price, the calculated base price values per equivalent are used (Step 1311). Using the previously disclosed techniques, a moving average is generated for relative actual equivalent price and relative equivalent base price (Step 1313). Thus a variety of imputed relative price variables can be generated (e.g., relative equivalent price, relative equivalent base price, etc.).

C. Imputed Base Volume Variable

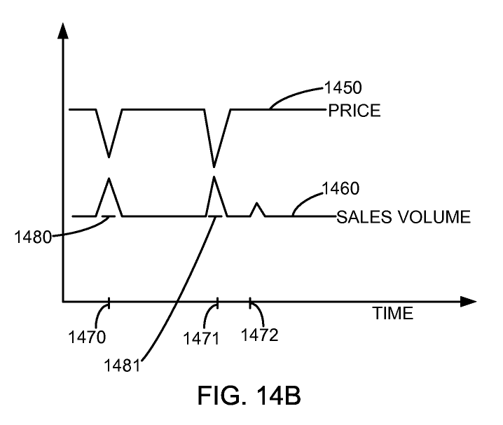

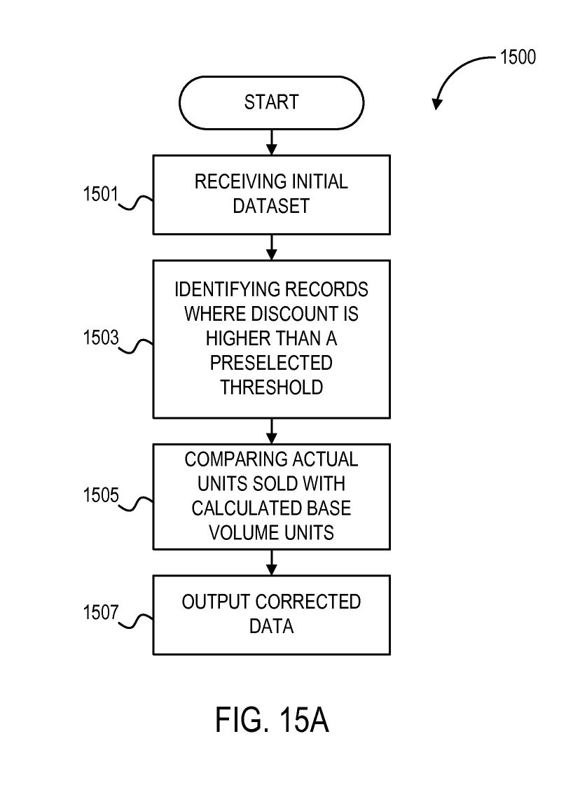

A flowchart 1400 shown in FIG. 14A illustrates one embodiment for generating an imputed base volume variable. Base volume refers to the volume of product units sold in the absence of discount pricing or other promotional effects. Base volume is also referred to herein as simply “base units”. The determination of base volume begins by receiving the cleansed initial dataset information for each product and store (Step 1401). The initial dataset information is processed to determine “non-promoted dates” (Step 1403), i.e. dates where the products are not significantly price discounted. Using the non-promoted data subset, an average value for “units” and a STD is calculated (i.e., an average value for product unit sales volume for each product during the non-promoted dates is calculated) (Step 1405). This value shall be referred to as the “non-promoted average units”. An initial value for base units (“initial base units”) is now determined (Step 1407).

This principle can be more readily understood with reference to FIG. 14B. The price behavior 1450 can be compared with sales behavior 1460. Typically, when the price drops below a certain level, sales volume increases. This can be seen at time periods 1470, 1471. In such a case, the actual units sold (more than usual) are not included in a base volume determination. Rather, those records are replaced with the average volume value for the non-promoted dates (the non-promoted average unit value, shown with the dotted lines 1480, 1481). However, where a sales volume increases during a period of negligible discount (e.g., less than 2%), such as shown for time period 1472, the actual units sold (actual sales volume) are used in the calculation of base volume. However, if the records show a sales volume increase 1472 which is too large (e.g., greater than 1.5 standard deviations from the non-promoted average unit value), it is assumed that some other factor besides price is influencing unit volume and the actual unit value is not used for initial base units but is replaced by the non-promoted average unit value.

A calculated base volume value is now determined (Step 1409). This is accomplished by defining a time window. For each store and product, the average value of “initial base units” is calculated for each time window. This value is referred to as “average base units”. This value is calculated for a series of time windows to generate a moving average of “average base units”. This moving average of the average base units over the modeled time interval is defined as the “base volume variable”.

D. Supplemental Error Detection and Correction

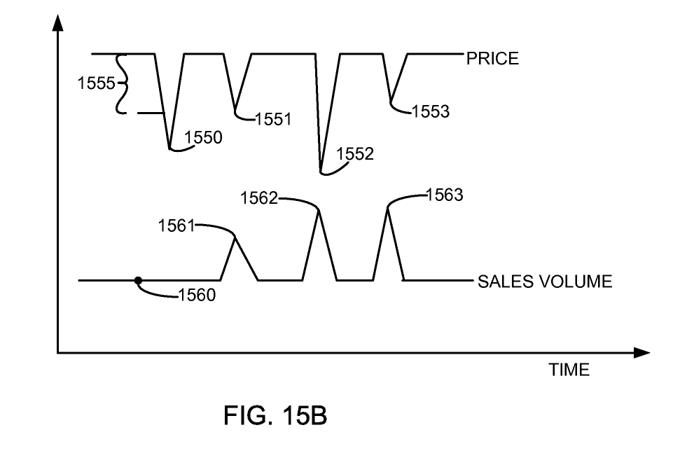

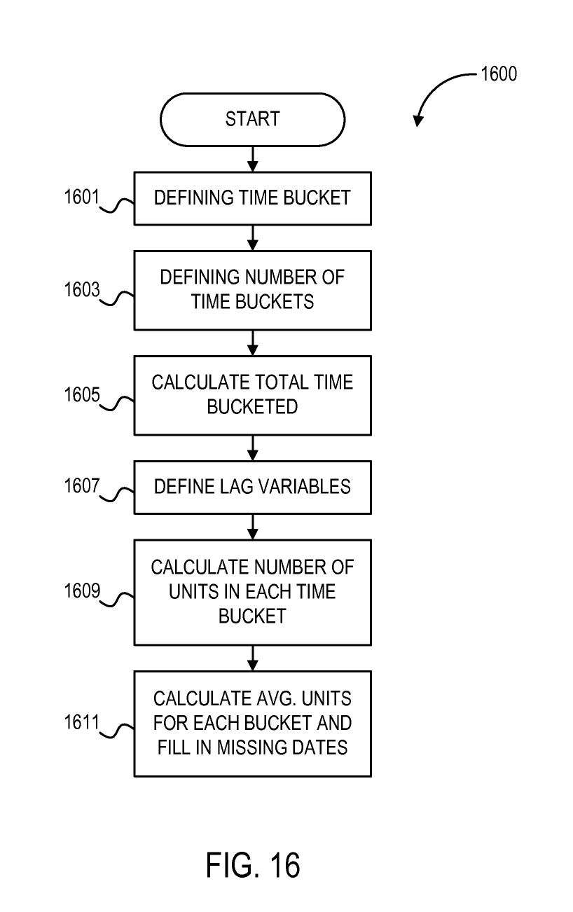

Based on previously determined discount information, supplementary error detection and correction may be used to correct price outliers. A flowchart 1500 illustrated in FIG. 15A shows one embodiment for accomplishing such supplementary error detection and correction. Such correction begins by receiving the cleaned initial dataset information for each product and store (Step 1501). In addition the previously calculated discount information is also input, or alternatively, the discount information (e.g., ΔP/BP) can be calculated as needed. The initial dataset and discount information is processed to identify discounts higher than a preselected threshold (e.g., 60% discount) (Step 1503). For those time periods (e.g., weeks) having price discounts higher than the preselected threshold (e.g., greater than 60%), a comparison of actual units sold to calculated base volume units (as calculated above) is made (Step 1505).

The concepts are similar to that illustrated in FIG. 14B and may be more easily illustrated with reference to FIG. 15B. The principles of this aspect of the present invention are directed toward finding unexplained price aberrations. For example, referring to FIG. 15B, price discounts are depicted at data points 1550, 1551, 1552, and 1553. Also, corresponding sales increases are depicted by at data points 1561, 1562, and 1563. The data point 1550 has a discount greater than the threshold 1555 (e.g., 60%). So an analysis is made of data point 1550.

E. Determining Imputed Variables which Correct for the Effect of Consumer Stockpiling

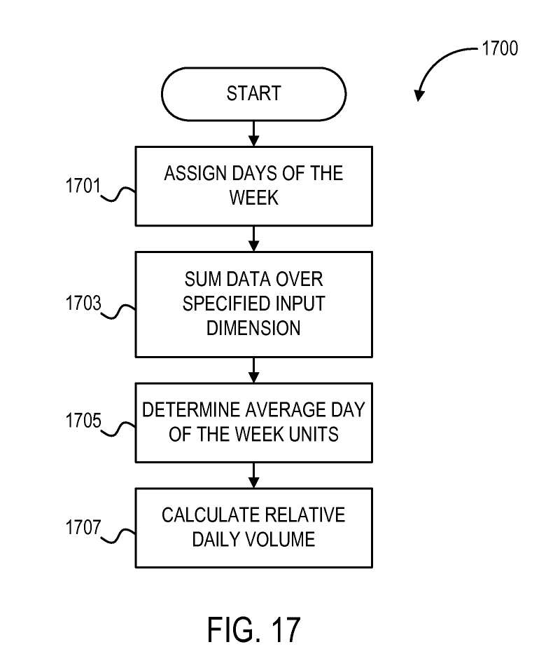

With reference to FIG. 16, a flowchart 1600 illustrating a method embodiment for generating stockpiling variables is depicted. The pictured embodiment 1600 begins by defining the size of a “time bucket”(m), for example, the size (m) of the bucket can be measured in days (Step 1601). Additionally, the number (τ) of time buckets to be used is also defined (Step 1603). The total amount of time “bucketed” (m×τ) is calculated (Step 1605).

“Lag” variables which define the number of product units sold (“units”) in the time leading up to the analyzed date are defined (Step 1607). Then the total number of product units sold is calculated for each defined time bucket (Step 1609). Correction can be made at the “front end” of the modeled time interval.

If working near the front end of a dataset, units from previous weeks cannot always be defined and in their place an averaged value for bucket sum can be used (Step 1611). The idea is to detect and integrate the effects of consumer stockpiling on into a predictive sales model.

F. Day of the Week Analysis

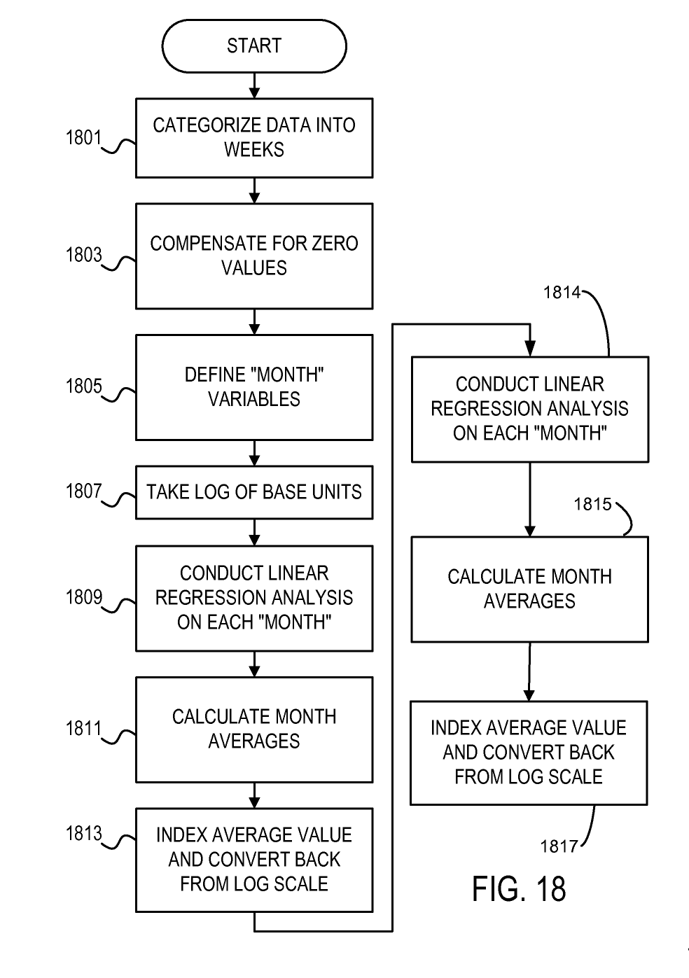

With reference to FIG. 17, a flowchart 1700 illustrating one embodiment for determining a Day of the Week variable is shown. It is necessary to have data on a daily basis for a determination of Day of the Week effects. In accordance with the principles of the present invention the embodiment begins by assigning the days of the week numerical values (Step 1701). Once categorized by day of the week the product units (sold) are summed for a specified dimension or set of dimensions. Dimension as used herein means a specified input variable including, but not limited to, Product, Brand, Demand Group, Store, Region, Store Format, and other input variable which may yield useful information (Step 1703). For each Day of Week and each dimension specified, the average units (sold) are determined (Step 1705). For each date, a “relative daily volume” variable is also determined (Step 1707). This information may prove valuable to a client merchant and can comprise an input variable for other econometric models.

G. Imputed Seasonality Variable Generation

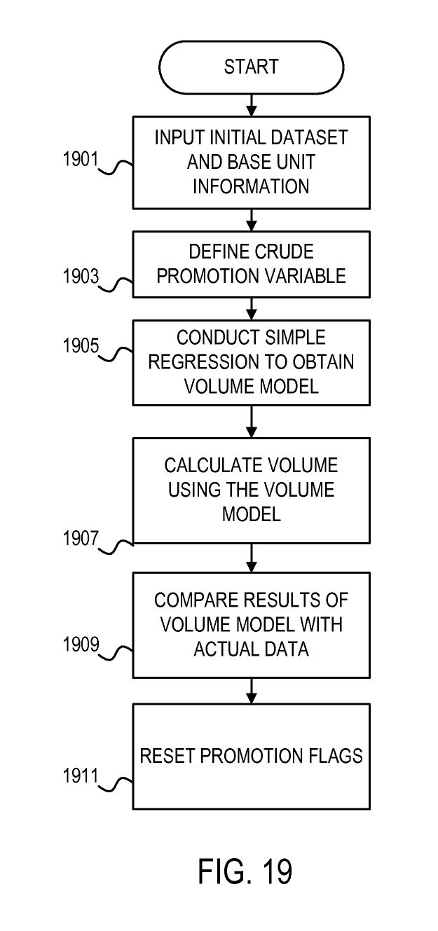

Another useful imputed variable is an imputed seasonality variable for determining seasonal variations in sales volume. Referring to FIG. 18, a flowchart 1800 illustrating one embodiment in accordance with the present invention for determining an imputed seasonality variable is shown. The process begins with categorizing the data into weekly data records, if necessary (Step 1801). Zero values and missing records are then compensated for (Step 1803). “Month” variables are then defined (Step 1805). A logarithm of base units is then taken (Step 1807). Linear regressions are performed on each “Month” (Step 1809). “Months” are averaged over a specified dimension (Step 1811). Indexes are averaged and converted back from log scale to original scale (Step 1813). The average of normalized estimates are calculated and used as Seasonality index (Step 1815). Individual holidays are estimated and exported as imputed seasonality variables (Step 1817).

H. Imputed Promotion Variable

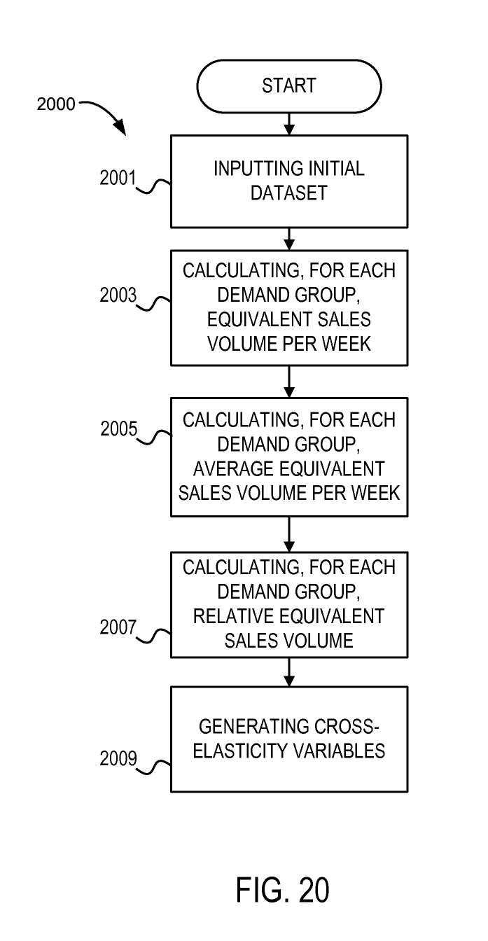

Another useful variable is a variable which can predict promotional effects. FIG. 19 provides a flowchart illustrating an embodiment enabling the generation of imputed promotional variables in accordance with the principles of the present invention. Such a variable can be imputed using actual pricing information, actual product unit sales data, and calculated value for average base units (as calculated above). This leads to a calculation of an imputed promotional variable which takes into consideration the entire range of promotional effects.

Referring back to FIG. 19, the process begins by inputting the cleansed initial dataset and the calculated average base units information (Step 1901). A crude promotional variable is then determined (Step 1903). Such a crude promotional variable can be defined using promotion flags. A simple regression analysis, as is known to those having ordinary skill in the art, (e.g., a mixed effects regression) is run on sales volume to obtain a model for predicting sales volume (Step 1905). Using the model a sample calculation of sales volume is performed (Step 1907). The results of the model are compared with the actual sales data to further refine the promotion flags (Step 1909). If the sales volume is underpredicted (by the model) by greater than some selected percentage (e.g., 30-50%), the promotion flag may be set to reflect the effects of a probable non-discount promotional effect. Since the remaining modeled results more closely approximate actual sales behavior, the promotion flags for those results are not reset (Step 1911). The newly defined promotion flags are incorporated into a new model for defining the imputed promotional variable.

I. Imputed Cross-Elasticity Variable

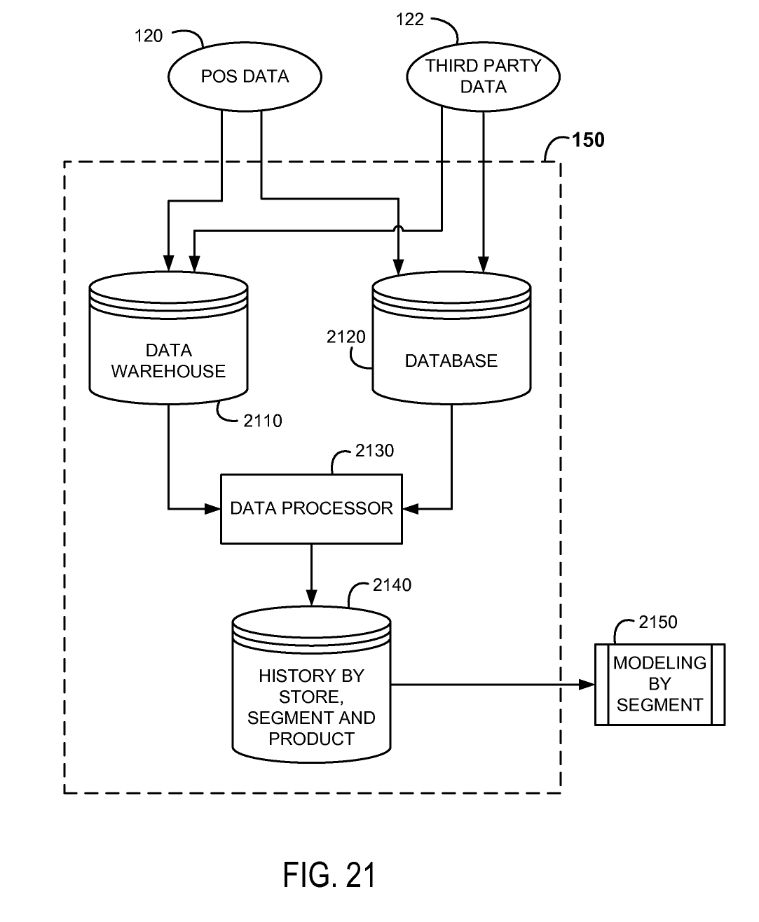

Another useful variable is a cross-elasticity variable. FIG. 20 depicts a flowchart 2000 which illustrates the generation of cross-elasticity variables in accordance with the principles of the present invention. The generation of an imputed cross-elasticity variable allows the analysis of the effects of a demand group on other demand groups within the same category. Here, a category describes a group of related demand groups which encompass highly substitutable products and complementary products. Typical examples of categories are, among many others, Italian foods, breakfast foods, or soft drinks.

The initial dataset information is input into the system (Step 2001). For each demand group the total equivalent sales volume for each store is calculated for each time period (for purposes of this illustration the time period is a week) during the modeled time interval (Step 2003). For each week and each demand group, the average total equivalent sales volume for each store is calculated for each week over the modeled time interval (Step 2005). For each demand group the relative equivalent sales volume for each store is calculated for each week (Step 2007). The relative demand group equivalent sales volume for the other demand groups is quantified and treated as a variable in the calculation of sales volume of the first demand group, thereby generating cross-elasticity variables (Step 2009).

The calculated imputed variables and data are outputted from the Imputed Variable Generator 304 to the Coefficient Estimator 308. Some of the imputed variables may also be provided to the Financial Model Engine 108.

### B. Coefficient Estimator

The Coefficient Estimator 308 uses the imputed variables and data to estimate coefficients, which may be used in an equation to predict demand. In a preferred embodiment of the invention, sales for a demand group (S) is calculated and a market share (F) for a particular product is calculated, so that demand (D) for a particular product is estimated by D=S·F. A demand group is defined as a collection of highly substitutable products. In the preferred embodiments, the imputed variables and equations for sales (S) of a demand group and market share (F) are as follows:

1. Modeling Framework

The econometric modeling engine uses one or more of statistical techniques, including, but not limited to, linear and non-linear regressions, hierarchical regressions, mixed-effect models, Bayesian techniques incorporating priors, and machine learning techniques. Mixed-effect models are more robust with regards to missing or insufficient data. Further, mixed-effect models allows for a framework of sharing information across various dimensions in the model, enabling better estimates. Bayesian techniques with prior information can incorporate all the features of the mixed effect models and, in addition, allow the modeler to use their knowledge about the prior distribution of coefficients to guide the model estimation.

### III. Financial Model Engine

The Financial Model Engine 108 receives data 132 from the Stores 124 and may receive imputed variables (such as baseline sales and baseline prices) and data from the Econometric Engine 104 to calculate fixed and variable costs for the sale of each item.

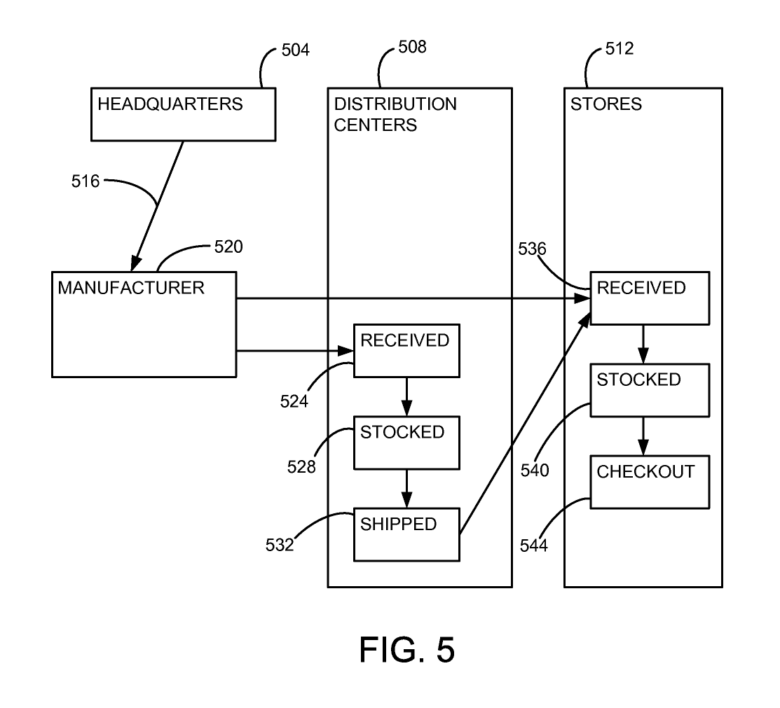

To facilitate understanding, FIG. 5 is an exemplary block diagram to illustrate some of the transaction costs that occur in retail businesses of a chain of stores. The chain of stores may have a headquarters 504, distribution centers 508, and stores 512. The headquarters 504 may place an order 516 to a manufacturer 520 for goods supplied by the manufacturer 520, which generates an order placement cost. The manufacturer 520 may ship the goods to one of the distribution centers 508. The receiving of the goods by the distribution center 508 generates a receiving cost 524, a cost for stocking the goods 528, and a cost for shipping the goods 532 to one of the stores 512. The store 512 receives the goods from one of the distribution centers 508 or from the manufacturer 520, which generates a receiving cost 536 and a cost for stocking the goods 540. When a customer purchases the item, the stores 512 incur a check-out cost 544.

The Financial Model Engine 108 should be flexible enough to provide a cost model for these different procedures. These different costs may have variable cost components where the cost of an item is a function of the amount of sales of the item and fixed cost components where the cost of an item is not a function of the amount of sales of the item. Financial Model Engine 108, thus, may generate a model that accounts for procurement costs in addition to the various costs associated with conducting business.

### IV. Optimization Engine and Support Tool

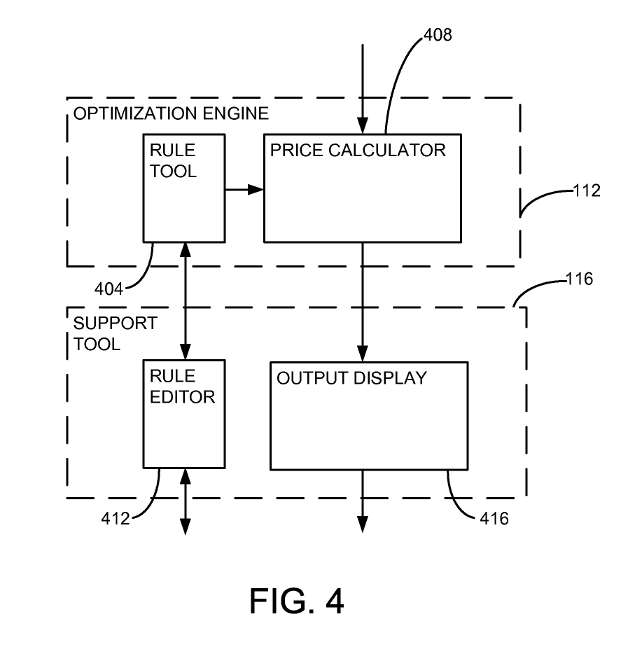

FIG. 4 is a more detailed schematic view of the Optimization Engine 112 and the Support Tool 116. The Optimization Engine 112 comprises a rule tool 404 and a price calculator 408. The Support Tool 116 comprises a rule editor 412 and an output display 416.

In operation, the client (stores 124) may access the rule editor 412 of the Support Tool 116 and provides client defined rule parameters (step 228). If a client does not set a parameter for a particular rule, a default value is used. Some of the rule parameters set by the client may be constraints to the overall weighted price advance or decline, branding price rules, size pricing rules, unit pricing rules, line pricing rules, and cluster pricing rules. The client defined parameters for these rules are provided to the rule tool 404 of the Optimization Engine 112 from the rule editor 412 of the Support Tool 116. Within the rule tool 404, there may be other rules, which are not client defined, such as a group sales equation rule. The rule parameters are outputted from the rule tool 404 to the price calculator 408. The demand coefficients 128 and cost data 136 are also inputted into the price calculator 408. The client may also provide to the price calculator 408 through the Support Tool 116 a desired optimization scenario rules. Some examples of scenarios may be to optimize prices to provide the optimum profit, set one promotional price and the optimization of all remaining prices to optimize profit, or optimized prices to provide a specified volume of sales for a designated product and to optimize price. The price calculator 408 then calculates optimized prices. The price calculator 408 outputs the optimized prices to the output display 416 of the Support Tool 116, which allows the Stores 124 to receive the optimized pricing (step 232).

### V. Modeling by Segment

### A. System Overview

FIG. 21 is a more detailed schematic view of the customer Segment Data Organizer 150 useful for aggregating transaction data in such a way as to enables coefficient generation by consumer segments, in accordance with some embodiment. Here, the Segment Data Organizer 150 receives Point Of Sales (POS) Data 120 and Third Party Data 122 to populate a data Warehouse 2110 and a Database 2120. The Third Party Data 122, in some embodiments, includes a listing of customers belonging to specific consumer segments. Consumer segmentation is known, and most retailers have internal or contracted teams dedicated to dividing known consumers into segments. Note, often a consumer loyalty program is utilized in determining consumer identity for segmentation; however, any identifying material may be utilized for this purpose. These include payment identification from financial institutions, tracking software (i.e., cookies) on a computer in an on-line shopping environment, surveys, biometric data, shopping behaviors, observation (age/gender/ethnicity, for example) and the like. While many embodiments of the modeling by segment system rely upon receiving listings of consumers pre-segmented, it is considered within the scope of some embodiments to be enabled to generate segments as well utilizing identification data and shopping histories.

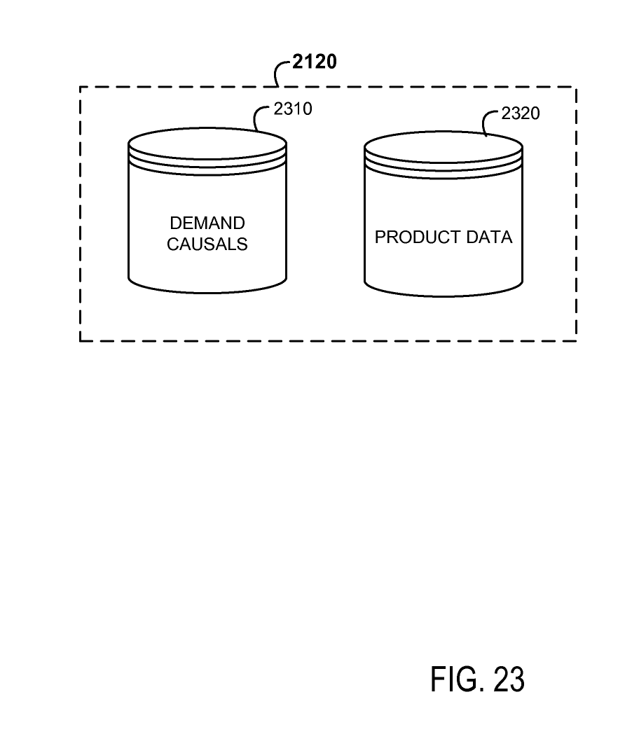

While the Warehouse 2110 and a Database 2120 are illustrated as being separate physical entities, this is not always required in some embodiments. The separating in the figure of the Warehouse 2110 and a Database 2120 is a logical separation of the data contained therein as well as function. However, in some cases all data may be stored within a single, multiple, or diffuse memory storage devices. FIG. 22 is a more detailed schematic view of the Data Warehouse 2110, in accordance with some embodiment. The Data Warehouse 2110 may include three logically distinct datasets, including Segmentation Data 2210, Transaction Log (T-log) with Consumer Identification Data 2220, and Aggregated Data 2230. The Segmentation Data 2210, as noted above, is typically populated from data received from the third parties, but may also be produced as a part of the tool. These third parties often include the retailer, an industry group, or some contracted analytics group dedicated to segmenting the consumer market. However, as noted, given consumer identified T-log data, it may also be possible to group consumers into appropriate segments by looking for similarities in their purchasing behaviors.

The result of cross referencing the Transaction log with Consumer ID Data 2220 by known Segmentation Data 2210 enables the logs to be grouped by segments. This aggregation results in a clustering of transaction logs by segment. The logs may likewise be aggregated by a given time window. In some embodiments, the aggregations may likewise be performed by store, store cluster, or regional division (location).

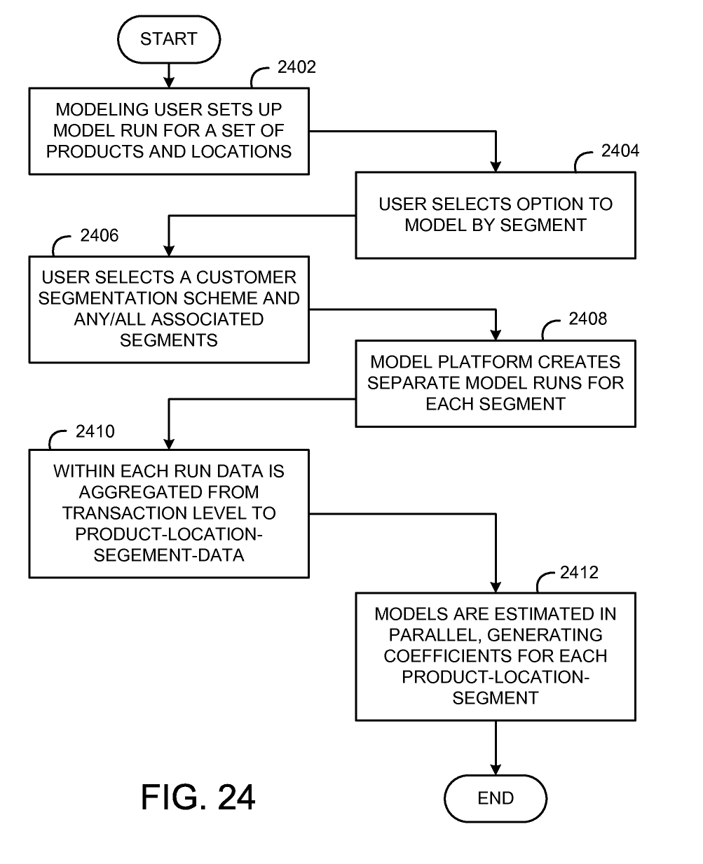

FIG. 23 is a more detailed schematic view of the Database 2120, which includes processed Demand Causals 2310 and Product Data 2320, in accordance with some embodiment. Coefficients generated in the Econometric Engine 104 may be returned to the Database 2120 for storage as Demand Causals 2310 in order to continually refine the system.

Returning to FIG. 21, Data from the Warehouse 2110 and a Database 2120 is manipulated by a Data Processor 2130 which aggregates transactional data. These aggregations may be stored within a third History by Store, Segment and Product Dataset 2140. This aggregate dataset may then be output, in some embodiments, to the econometric engine and optimization engine for modeling by segment 2150. This modeling is identical to modeling the entire transactional history, but instead feeds the modeling system a limited aggregate input such that the output is a model for the limited segment of interest. Only aggregate data pertaining to a segment of interest is output for modeling, in some embodiments.

### A. Methods for Modeling by Segment

FIG. 24 is a workflow flowchart for modeling by segment, in accordance with some embodiment. The process begins with the user setting up a model run for a set of products and locations (step 2402). The user then may select the option to model by segment (step 2404). The user may then select a consumer segmentation scheme and segments which are desired for modeling (step 2406). Each of these user selections may be performed by utilizing an interface such as that seen at FIG. 31, part 3110. In this example Interface 3110, the user has the option to select model type (retail, by segment, markdown, standalone module, etc.) as well as name the modeling run for future recall. The user may also have the option, in some embodiments, to select location breadth of the model (i.e., for all stores, a division, store groups, individual store, etc.). Data aggregation used for the model (such as segment and location selections) may be viewed through a selection button, which may open a popup menu (or similar graphical interface) which displays specifics of the aggregation. For example, in the instant Interface 3110, selecting the “View Segments” button brings up a popup window with segment data. The segmentation scheme may be provided in a pull down menu at the top. The segments of that scheme may then be displayed for selection in modeling. Illustrated in this example is segmentations by “life stages”; however, other segmentation schemes are also considered. For example, segmentations may be performed by disposable income availability, ethnicity, spend habits, age, gender, or virtually any useful defining characteristic of interest. The segments of interest for processing are selected by the user, and the “ok” button may be selected to close the window and save the user segment selection, in some embodiments.

Returning to the example workflow of FIG. 24, after the user has made all of the requisite selections, the model platform may create separate model runs for each segment (process 2408). For each of these runs, data is aggregated from transaction level to a store, product, location and segment level of data (process 2410). The models are estimated, thereby generating coefficients for each product/location/segment (process 2412). This estimation may be performed in parallel, in some embodiments. It is also possible that the estimation utilizes heuristics in order to efficiently generate the coefficients.

FIG. 25A is a flow chart depicting a process flow by which transaction data is modeled by customer segments, in accordance with some embodiment. This example process provides greater detail of the operation of some embodiments of the model by segment system. In this process the system receives transaction log (T log) level data (step 2502). Often this transaction log data is a compilation of point of sales data over a given time period. Where available, the T log data may be associated with identification data, often through a loyalty program, financial data or the like. Further, the system may receive customer ID segment data (step 2504). Segment ID may include a listing of customer IDs grouped by segments. In some alternate embodiments, the segment ID data may include segments with information regarding attributes which result in consumers being divided into segments. For example, a segment scheme may be considered where consumer spend over time is the only consideration. In such an embodiment, segments may be delineated by top 30% spend, bottom 30% spend and remaining, for example. In these instances, the consumers may be readily assigned to segments on the fly. Lastly, as previously noted, it may be possible that the system is capable of generating segments, without third party input, through T log analysis for consumer behavior similarities of interest.

After all data has been received, the system may aggregate transactions by segment, location, date and product (step 2506). FIG. 25B provides a more detailed process diagram of this aggregation step. In this embodiment, the segment ID data is used to identify segments (step 2514). The T log data may be grouped by location (step 2516). Location may include all stores, or some sub-grouping of stores, such as a cluster by physical location, type, demographic similarity, length of time store has been opened/since last renovation, division, or even by singular stores.

Next, the transactions may be grouped by segment (step 2518). Here the identification data within the T log may be mapped to the identified segment data. Consumers with known identities, but which do not map to a known segment may be clustered as a ‘miscellaneous segment’ or may be discarded, as is desired. Likewise, T log data without identification data may be grouped as well, or, in some cases where loyalty programs have high penetration, may be discarded (step 2520).

Lastly, the T log data may be aggregated over a given time series for each product (step 2522). The result is an aggregated data across time (date), segment, location (store) and product. Returning to FIG. 25A, the process continues by inputting the aggregated T log data for the segments of interest into the econometric engine for generation of segment specific coefficient output (step 2508). Likewise, these segment specific coefficients may be utilized by the optimization engine to generate segment specific models. Coefficients (demand causals) may be stored for output at a future use (step 2510), in some embodiments. Then an inquiry may be made if additional segments are to be modeled (step 2512), whereby additional runs may be made for each segment of interest until all desired segments have been modeled. In such a way, detailed response information for a segment to pricing of products may be modeled and utilized to generate retailer insights, segment specific merchandising and marketing decisions (i.e. senior only discounts, student discounts, advertising targeting young families), and greater understanding of consumer behavior.

### C. Examples

Below is provided a number of limited examples designed to provide clarity to the process of modeling by consumer segment. These examples are provided as a means of clarifying the system and method and are not limiting to the scope of the embodiments.

FIG. 26 is an example diagram of generating models for transaction data, in accordance with some embodiment. In this example, transactions for all customers in a given store (or group of stores) is seen depicted at 2610. This transaction data is aggregated to a single time series of data for each product, seen at 2620. This gross aggregated data may then be utilized to produce models where a single set of elasticities is generated for each product, as shown at 2630. This process is utilized regularly to generate a demand model for profit maximization.

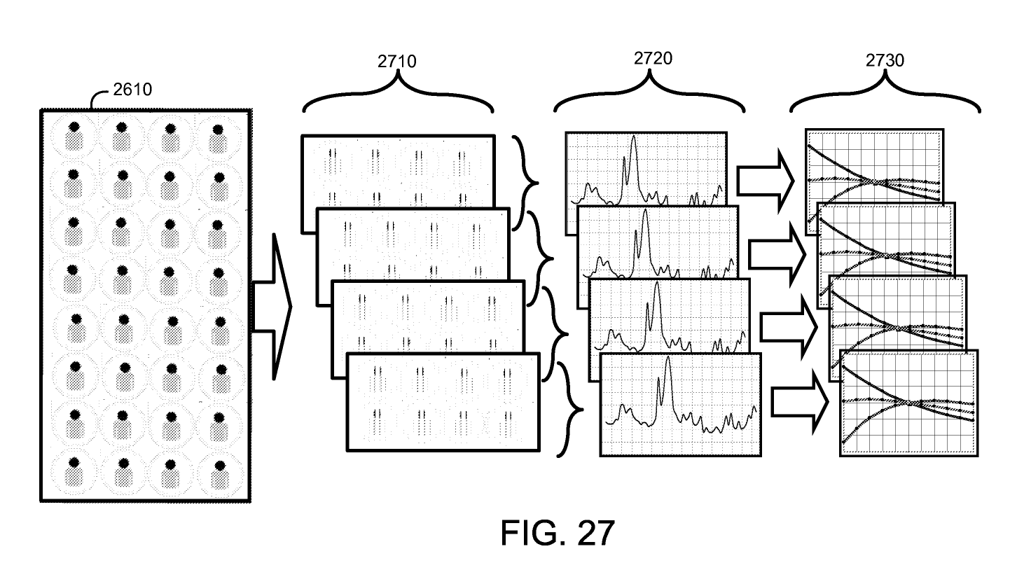

In contrast, FIG. 27 is an example diagram of generating models for segmented transaction data, in accordance with some embodiment. In this example, the starting data is identical to that utilized to generate models for transaction data. That is transactions for all customers in a given store (or group of stores) is seen depicted at 2610. However, instead of aggregating all transactions to a single time series, an initial aggregation is performed which groups transaction log data by segment, as shown at 2710. These sub-groupings of transaction log data are then each aggregated into a corresponding time series for each product, as seen at 2720. This results in multiple aggregated sets of data, each corresponding to a segment. Each of these segment/location/time/product aggregated data sets may then be utilized to generate a model of elasticity for the product, as seen at 2730. Thus, each product has any number of sets of elasticities, each set associated with a given segment.

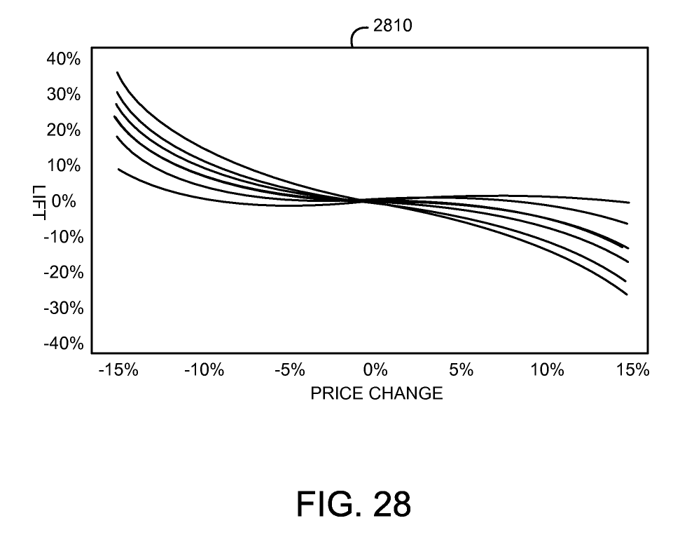

These multiple elasticities enable the analysis and forecasting of the impact of price or merchandizing decisions on distinct consumer segments. For example, FIG. 28 is an example plot diagram 2810 sales lift for a price change for numerous segments, in accordance with some embodiment. It may be seen here that different segments react differently to price changes than other segments.

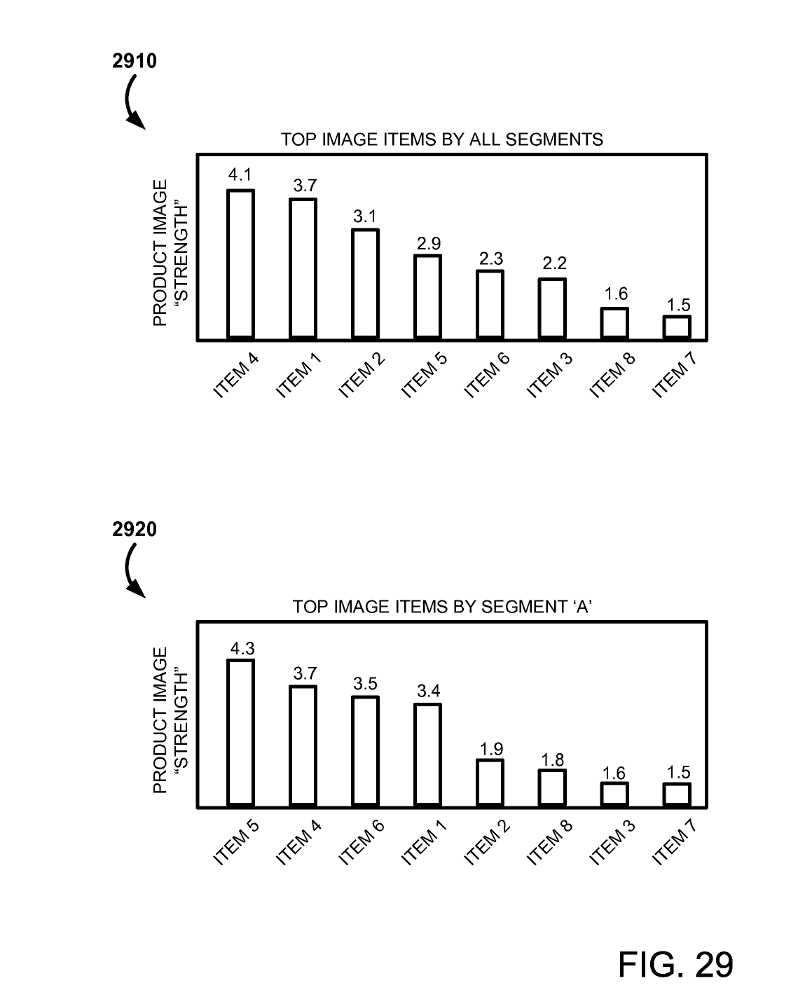

To place a finer point on this, FIG. 29 is an example pair of bar graphs illustrating item strength generally 2910 and by a selected segment 2920, in accordance with some embodiment. For purposes of this example, an item's “strength” may relate to items which generally have low elasticity to price changes, and is a high volume product. Alternatively, “strength” may correspond to image strength, which may be used to identify Key Value Item (KVI). Retailers may use Image Strength and KVI to identify products where they can create rules to ensure that they are competitive. They may also be able to increase profits by lowering the price of these goods if the increased volume generated compensates for the decrease in margin percentage due to the price change. In this example, generally Item 4 is considered ‘strongest’ when viewing all transaction data. This may lead the retailer to slightly raise pricing on this product in order to generate increased profit. However, for Segment A, as seen on the segment specific Plot 2920, Item 5 is a higher strength item. This is because sales volume and elasticity for this item are different between the specific segments, as compared to all segments combined.

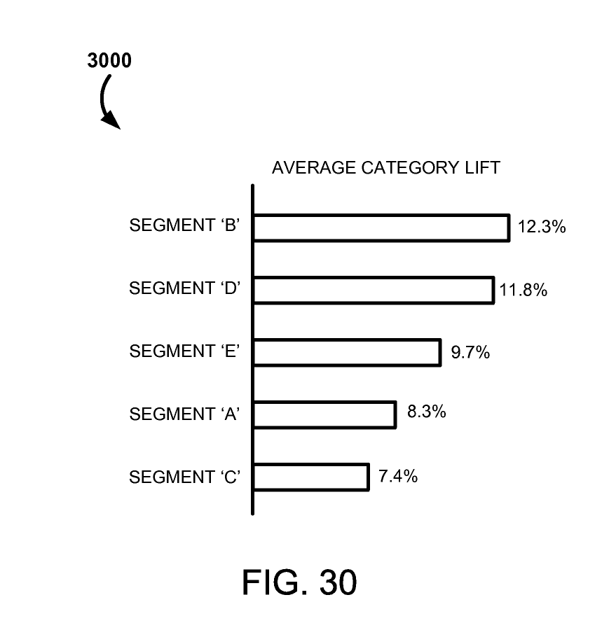

Lastly, FIG. 30 is an example plot of average category lift by segment for a proposed promotional activity, in accordance with some embodiment, and shown at 3000. The illustrative chart, for example, may indicate the lift for a given category for a 10% decrease in price. This illustrates that customer segments may have significant differences in pricing sensitivity across product categories (or even individual products). Also of interest, it is possible that high value segments (responsible for a large portion of retailer profit) may be more, or less, sensitive to price changes than expected. These insights may prompt retailers to alter promotional activity in a profitable manner.

### VI. System Platform

FIGS. 7A and 7B illustrate a computer system 900, which forms part of the network 10 and is suitable for implementing embodiments of the present invention. FIG. 7A shows one possible physical form of the computer system. Of course, the computer system may have many physical forms ranging from an integrated circuit, a printed circuit board, and a small handheld device up to a huge super computer. Computer system 900 includes a monitor 902, a display 904, a housing 906, a disk drive 908, a keyboard 910, and a mouse 912. Disk 914 is a computer-readable medium used to transfer data to and from computer system 900.

FIG. 7B is an example of a block diagram for computer system 900. Attached to system bus 920 are a wide variety of subsystems. Processor(s) 922 (also referred to as central processing units, or CPUs) are coupled to storage devices, including memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 926 is also coupled bi-directionally to CPU 922; it provides additional data storage capacity and may also include any of the computer-readable media described below. Fixed disk 926 may be used to store programs, data, and the like and is typically a secondary storage medium (such as a hard disk) that is slower than primary storage. It will be appreciated that the information retained within fixed disk 926 may, in appropriate cases, be incorporated in standard fashion as virtual memory in memory 924. Removable disk 914 may take the form of any of the computer-readable media described below.

CPU 922 is also coupled to a variety of input/output devices, such as display 904, keyboard 910, mouse 912 and speakers 930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 922 optionally may be coupled to another computer or telecommunications network using network interface 940. With such a network interface, it is contemplated that the CPU might receive information from the network, or might output information to the network in the course of performing the above-described method steps. Furthermore, method embodiments may execute solely upon CPU 922 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

FIG. 8 is a schematic illustration of an embodiment of the invention that functions over a computer network 800. The network 800 may be a local area network (LAN) or a wide area network (WAN). An example of a LAN is a private network used by a mid-sized company with a building complex. Publicly accessible WANs include the Internet, cellular telephone network, satellite systems and plain-old-telephone systems (POTS). Examples of private WANs include those used by multi-national corporations for their internal information system needs. The network 800 may also be a combination of private and/or public LANs and/or WANs. In such an embodiment the Price Optimizing System 100 is connected to the network 800. The Stores 124 are also connected to the network 800. The Stores 124 are able to bi-directionally communicate with the Price Optimizing System 100 over the network 800. Additionally, in embodiments where the Segment Data Organizer 150 is not integrated within the pricing optimization system, the Stores 124 are likewise able to bi-directionally communicate with the Segment Data Organizer 150 over the network 800.

Additionally, in some embodiments, the system may be hosted on a web platform. A browser or similar web component may be used to access the Likelihood of loss engine. By utilizing internet based services, retailers may be able to access the system from any location.

In the specification, examples of product are not intended to limit products covered by the claims. Products may for example include food, hardware, software, real estate, financial devices, intellectual property, raw material, and services. The products may be sold wholesale or retail, in a brick and mortar store or over the Internet, or through other sales methods.

In sum, the present invention provides a system and methods for modeling elasticity by consumer segments. The advantages of such a system include the ability to implement cost efficient customer segment specific promotion activity, customer segment insights and possible downstream efficiency increases of a pricing optimization.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for modeling demand by consumer segments, useful in association with a price or promotion optimization system, the method comprising:
retrieving customer identification data, wherein the customer identification data includes groupings of customers by more than one customer segment;
aggregating, using a processor, transaction data by each of the more than one customer segment; and
modeling aggregated transaction data for at least one of the more than one customer segment, wherein the modeling computes elasticities for products for the at least one of the more than one customer segment.

2. The method as recited in claim 1, further comprising storing the computed elasticity for products for the at least one of the more than one customer segment.

3. The method as recited in claim 2, further comprising generating optimized prices and promotions using the computed elasticity for products for the at least one of the more than one customer segment.

4. The method as recited in claim 1, wherein aggregating the transaction data by each of the more than one customer segments includes aggregating transaction data by the segment, product, a time series, and a location.

5. The method as recited in claim 1, wherein the transaction data includes identification information associated with each transaction.

6. The method as recited in claim 5, wherein the identification information is substantially gathered from loyalty memberships.

7. The method as recited in claim 5, wherein aggregating the transaction data by each of the more than one customer segment includes cross referencing the customer identification data with the identification information associated with each transaction.

8. The method as recited in claim 1, further comprising modeling demand for the products according to the at least one of the more than one customer segment using the computed elasticities.

9. The method as recited in claim 8, further comprising generating lifts for the products for at least one of the more than one customer segment in response to a promotional activity.

10. A system for modeling demand by consumer segments, useful in association with a price optimization system, the system comprising:
a segment data organizer including a processor configurable to retrieve transaction data, and retrieve customer identification data, wherein the customer identification data includes groupings of customers by more than one customer segment, and wherein the segment data organizer is further configurable to aggregate the transaction data by each of the more than one customer segment; and
an econometric engine configurable to compute elasticities for products for the at least one of the more than one customer segment using the aggregated transaction data by each of the more than one customer segment.

11. The system as recited in claim 10, further comprising a database configurable to store the computed elasticity for products for the at least one of the more than one customer segment.

12. The system as recited in claim 11, further comprising an optimization engine configurable to generate optimized prices using the computed elasticity for products for the at least one of the more than one customer segment.

13. The system as recited in claim 10, wherein the segment organizer aggregates transaction data by the segment, product, a time series, and a location.

14. The system as recited in claim 10, wherein the transaction data includes identification information associated with each transaction.

15. The system as recited in claim 14, wherein the identification information is substantially gathered from loyalty memberships.

16. The system as recited in claim 14, wherein the segment organizer cross references the customer identification data with the identification information associated with each transaction.

17. The system as recited in claim 10, further comprising an optimization engine configurable to model demand for the products according to the at least one of the more than one customer segment using the computed elasticities.

18. The system as recited in claim 17, wherein the optimization engine is further configurable to generate lifts for the products for at least one of the more than one customer segment in response to a promotional activity.
